(19) United States
(12) Patent Application Publication
(10) Pub. No.: US 2024/0351497 A1
(43) Pub. Date: Oct. 24, 2024

(54) SEAT ASSEMBLY

(71) Applicant: Lear Corporation, Southfield, MI (US)

(72) Inventors: Matthew Klais, Waterford, MI (US); Adarsha B. Madhu, Novi, MI (US); Chiranjeevi Chalavadi, Novi, MI (US); Stephen Redwood, Flat Rock, MI (US)

(73) Assignee: Lear Corporation, Southfield, MI (US)

(21) Appl. No.: 18/637,631

(22) Filed: Apr. 17, 2024

Related U.S. Application Data
(60) Provisional application No. 63/496,952, filed on Apr. 18, 2023.

(51) Int. Cl. B60N 2/90; B60N 2/02

(52) U.S. Cl. CPC B60N 2/995; B60N 2/02246

(57) ABSTRACT

A seat assembly, comprising: a seat base; a seat portion movably coupled to the seat base; and a seat portion adjuster coupled to the seat base and the seat portion, the seat portion adjuster including: a bracket connected to the seat base; a motor operably coupled to the bracket; and a linkage coupled to the seat portion, the bracket, and the motor.

### CROSS-REFERENCE TO RELATED APPLICATIONS

This application claims the benefit of and priority to U.S. Provisional Application 63/496,952, filed Apr. 18, 2023, the disclosure of which is hereby incorporated by reference in its entirety as though fully set forth herein.

### TECHNICAL FIELD

The present disclosure generally relates to seat assemblies, including seat assemblies that may include calf rests and/or seat assemblies that may be utilized with vehicles, for example.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a schematic side view generally illustrating an embodiment of a seat assembly with a seat portion in a retracted position according to teachings of the present disclosure.

FIG. 2 is a schematic side view generally illustrating an embodiment of a seat assembly with a seat portion in an extended position according to teachings of the present disclosure.

FIG. 3 is a perspective view generally illustrating an embodiment of a seat portion adjuster in a retracted position according to teachings of the present disclosure.

FIG. 4 is a front view generally illustrating an embodiment of a seat portion adjuster in a retracted position according to teachings of the present disclosure.

FIG. 5 is a side view generally illustrating an embodiment of a seat portion adjuster in a retracted position according to teachings of the present disclosure.

FIG. 6 is a perspective view generally illustrating an embodiment of a seat portion adjuster and a seat portion in a retracted position according to teachings of the present disclosure.

FIG. 7 is a cross-sectional view generally illustrating an embodiment of a seat assembly including a seat portion adjuster and a seat portion in a retracted position according to teachings of the present disclosure.

FIG. 8 is a side view generally illustrating an embodiment of a seat portion adjuster in an extended position according to teachings of the present disclosure.

FIG. 9 is a top view generally illustrating an embodiment of a seat portion adjuster in an extended position according to teachings of the present disclosure.

FIGS. 10-12 are side views generally illustrating an embodiment of a seat assembly including a seat portion adjuster and a seat portion in a retracted position, an intermediate position, and an extended position, respectively, according to teachings of the present disclosure.

FIGS. 13 and 14 are perspective views generally illustrating embodiments of a seat portion adjuster in a retracted position and an extended position, respectively, according to teachings of the present disclosure.

FIGS. 15 and 16 are perspective views generally illustrating embodiments of a seat portion adjuster and a seat portion in a retracted position according to teachings of the present disclosure.

FIGS. 17 and 18 are perspective views generally illustrating embodiments of a seat portion adjuster and a seat portion in an intermediate position according to teachings of the present disclosure.

FIGS. 19 and 20 are perspective views generally illustrating embodiments of a seat portion adjuster and a seat portion in an extended position according to teachings of the present disclosure.

FIGS. 21 and 22 are schematic front and side views, respectively, generally illustrating embodiments of a seat assembly including a seat portion adjuster and a seat portion in a retracted position according to teachings of the present disclosure.

FIG. 23 is a perspective view generally illustrating an embodiment of a seat portion adjuster in a retracted position according to teachings of the present disclosure.

FIG. 24 is a rear perspective view generally illustrating an embodiment of a seat portion adjuster in a retracted position according to teachings of the present disclosure.

FIG. 25 is a cross-sectional view generally illustrating an embodiment of a seat portion adjuster in a retracted position according to teachings of the present disclosure.

FIG. 26 is a cross-sectional perspective view generally illustrating an embodiment of a seat portion adjuster in a retracted position according to teachings of the present disclosure.

FIGS. 27 and 28 are perspective views generally illustrating an embodiment of a seat portion adjuster in an extended position according to teachings of the present disclosure.

FIG. 29 is a cross-sectional view generally illustrating an embodiment of a seat portion adjuster in an extended position according to teachings of the present disclosure.

FIG. 30 is a cross-sectional view generally illustrating an embodiment of a seat portion adjuster in an intermediate position according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

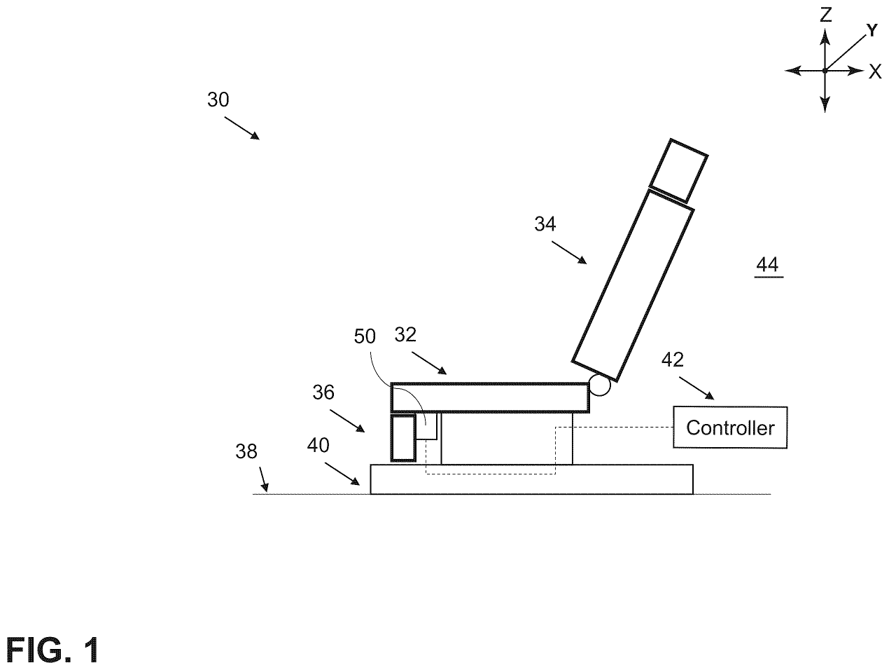

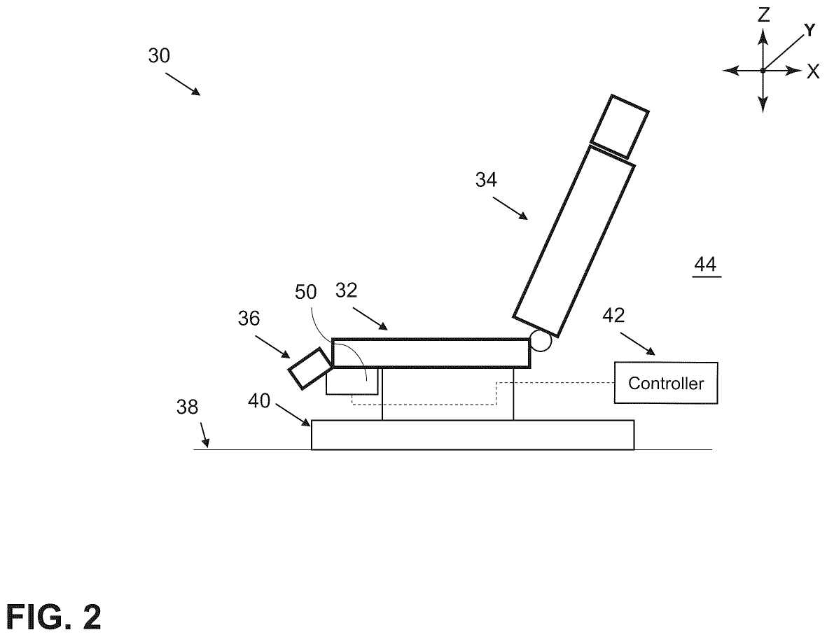

Referring to FIGS. 1 and 2, a seat assembly 30 including a seat base 32, a seat back 34, and a seat portion 36 is generally illustrated. Optionally, the seat assembly 30 includes or is connected to a track assembly 40 that movably connects the seat assembly 30 to a mounting surface 38, such as of a vehicle 44. The seat portion 36 is movably connected to the seat base 32 such that the seat portion 36 can move between a retracted position (see, e.g., FIG. 1) and an extended position (see, e.g., FIG. 2). The seat assembly 30 includes a seat portion adjuster 50 that moves the seat portion 36 to the retracted position, the extended position, and intermediate positions therebetween. A controller 42 is connected to the seat portion adjuster 50 to control operation thereof. The seat portion 36 can include and/or be configured as a calf rest disposed at or about a front of the seat base 32. The seat portion adjuster 50 may be configured as a calf rest adjuster. In the retracted position, the seat portion 36 can be substantially vertical and/or disposed at least partially under the seat base 32. In the extended position, the seat portion 36 can be disposed to function as an extension of the seat base 32, such as to support the calves of an occupant.

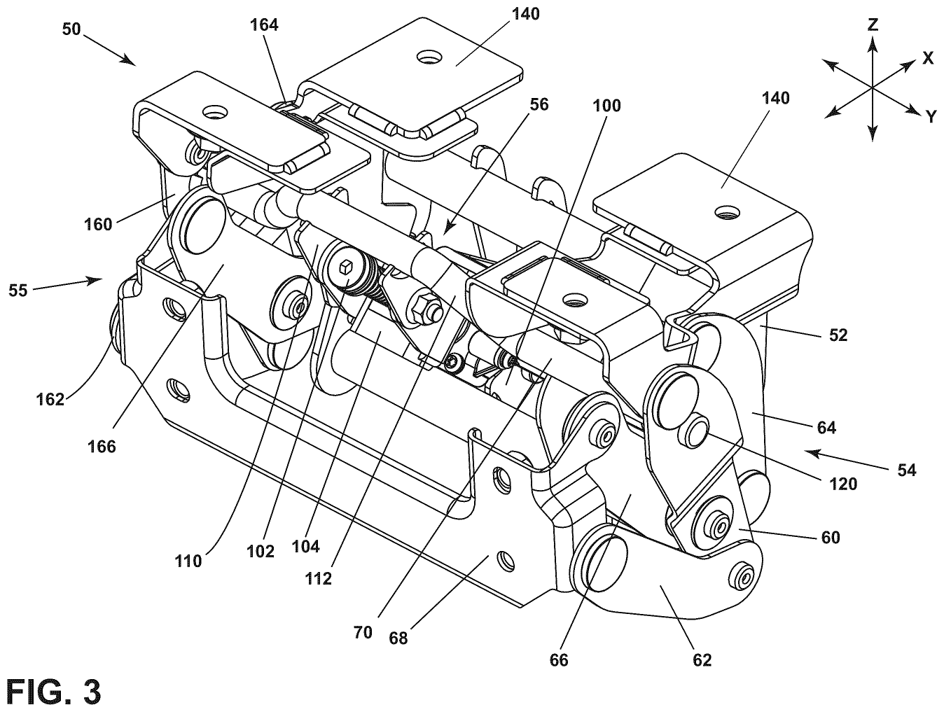

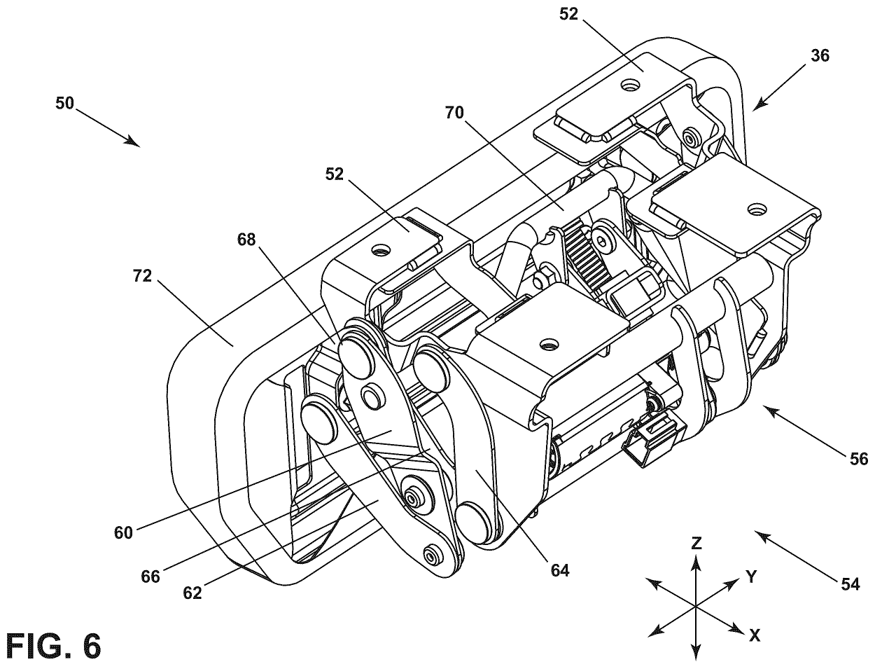

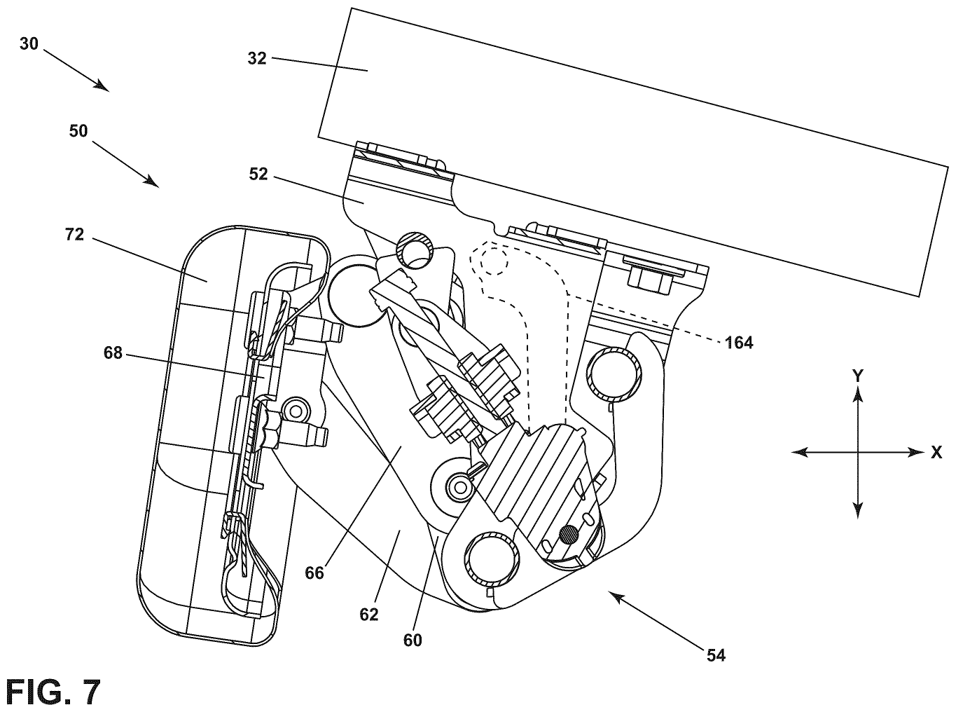

Referring to FIGS. 3-7, the seat portion adjuster 50 includes a bracket 52, a first linkage 54, a second linkage 55, an actuator 56, a seat portion bracket 68 (e.g., a calf rest bracket), and/or a cross member 70. The first linkage 54 includes a first lever 60, a second lever 62, a third lever 64, and/or a fourth lever 66. The second linkage 55 includes a second linkage first lever 160, a second linkage second lever 162, a second linkage third lever 164, and/or a second linkage fourth lever 166. The bracket 52 is connected to the seat base 32 (FIG. 1) and/or couples the seat portion adjuster 50 to the seat base 32. The first linkage 54 and/or the second linkage 55 movably couples the seat portion 36 (FIG. 1) to the seat base 32 (FIG. 1) via the bracket 52.

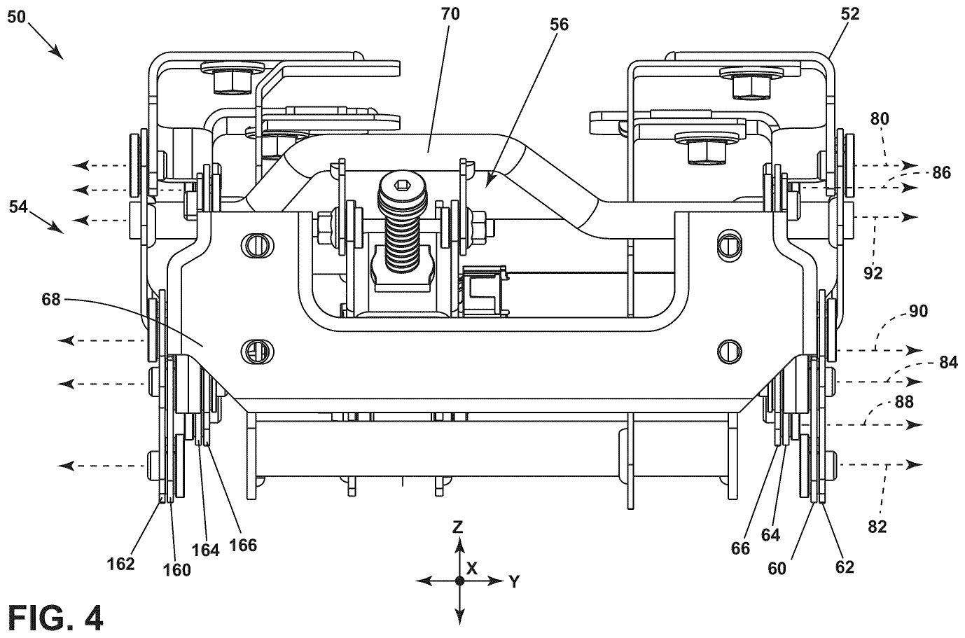

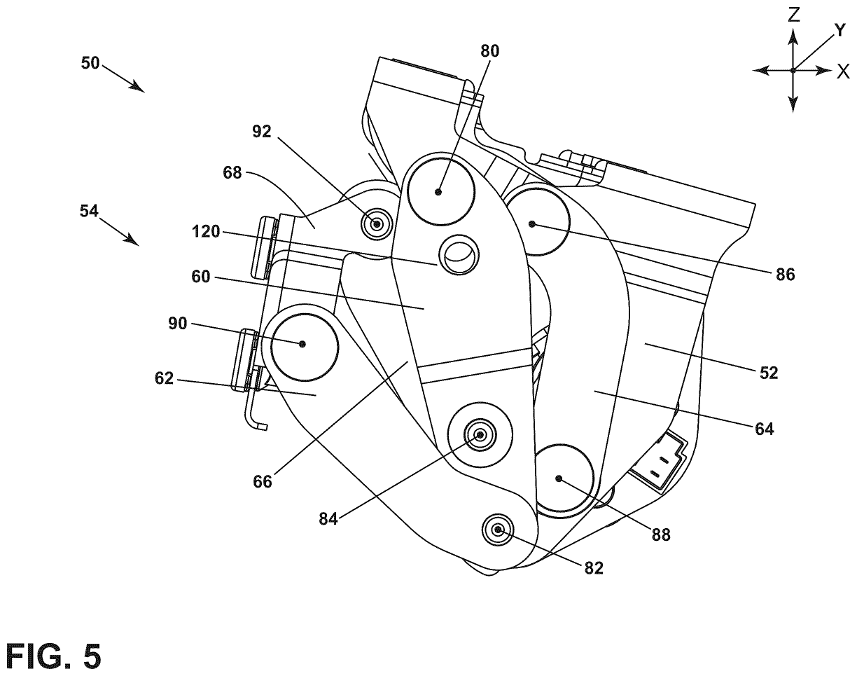

Referring to FIGS. 4 and 5, the first lever 60 is rotatably coupled to the bracket 52 at a first rotational axis 80. The first rotational axis 80 is fixed relative to the bracket 52. The first lever 60 is rotatably coupled to the second lever 62 at a second rotational axis 82 that moves relative to the bracket 52 (e.g., rotates about the first rotational axis 80). The first lever 60 is rotatably coupled to the fourth lever 66 at a third rotational axis 84 that moves relative to the bracket 52 (e.g., rotates about the first rotational axis 80). The first rotational axis 80 and the second rotational axis 82 are disposed at opposite ends of the first lever 60 with the third rotational axis 84 disposed therebetween.

The third lever 64 is rotatably coupled to the bracket 52 at a fourth rotational axis 86 that is fixed relative to the bracket 52. In some configurations, the fourth rotational axis 86 is disposed rearward of and/or at a lower height than the first rotational axis 80. The third lever 64 is rotatably coupled to the fourth lever 66 at a fifth rotational axis 88 that moves relative to the bracket 52 (e.g., rotates about the fourth rotational axis 86).

The second lever 62 is rotatably coupled to the seat portion bracket 68 at a sixth rotational axis 90 that moves relative to the bracket 52 and is fixed relative to the seat portion bracket 68. The fourth lever 66 is rotatably coupled to the seat portion bracket 68 at a seventh rotational axis 92 that moves relative to the bracket 52 and is fixed relative to the seat portion bracket 68. The sixth and seventh rotational axes 90, 92 are offset from each other in at least one direction (e.g., a vertical direction in the retracted position).

An example configuration of the actuator 56 is generally illustrated in FIGS. 3, 4, 6 and 7. As shown, the actuator 56 can include a motor 100, a threaded rod 102, and/or a nut 104. The nut 104 may be connected to the bracket 52 such that movement of the nut 104 is restricted (e.g., forward and rearward movement may be substantially prevented). The nut 104 can be engaged with the threaded rod 102. The motor 100 can be operably coupled with the threaded rod 102 such that actuation of the motor 100 causes rotation of the threaded rod 102. As the nut 104 may be substantially fixed, rotation of the threaded rod 102 may cause movement of the motor 100. The threaded rod 102 may be rotatably coupled with a cross member 70, such as via a flange 110. The cross member 70 may include an offset portion 112 that is radially offset from a central axis of the cross member 70. The offset portion 112 may, for example, include a generally C-shaped configuration. The flange 110 may be fixed to the cross member 70, such as to the offset portion 112. The threaded rod 102 may be coupled (e.g., rotatably) to the flange 110 such that actuation of the motor 100 causes rotation of the cross member 70.

The cross member 70 is coupled with the first lever 60 such that rotation of the cross member 70, such as via the actuator 56, causes rotation of the first lever 60 about the first rotational axis 80 (FIG. 4). In some configurations, the cross member 70 is connected to a first lever portion 120 of the first lever 60 that is offset from the first rotational axis 80, the second rotational axis 82, and/or the third rotational axis 84 (FIG. 5).

Rotation of the first lever 60 causes movement of the second rotational axis 82 and the third rotational axis 84 (e.g., rotation about the first rotational axis 80), which causes movement, such as rotation and translation, of second lever 62 and the fourth lever 66. Movement of the fourth lever 66 causes movement of the third lever 64 (e.g., rotation about the fourth rotational axis 86) and/or relative rotation of the third lever 64 and the fourth lever 66 about the fifth rotational axis 88 and/or movement of the fifth rotational axis 88 (e.g., rotation about the fourth rotational axis 86). Movement of the second lever 62 and the fourth lever 66 causes movement of the seat portion bracket 68, such as to or toward the retracted position or the extended position.

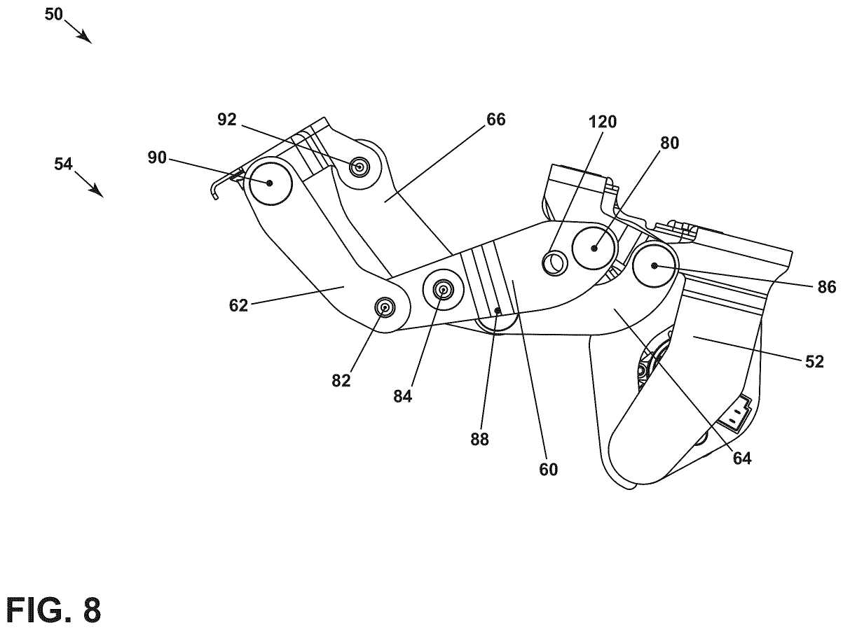

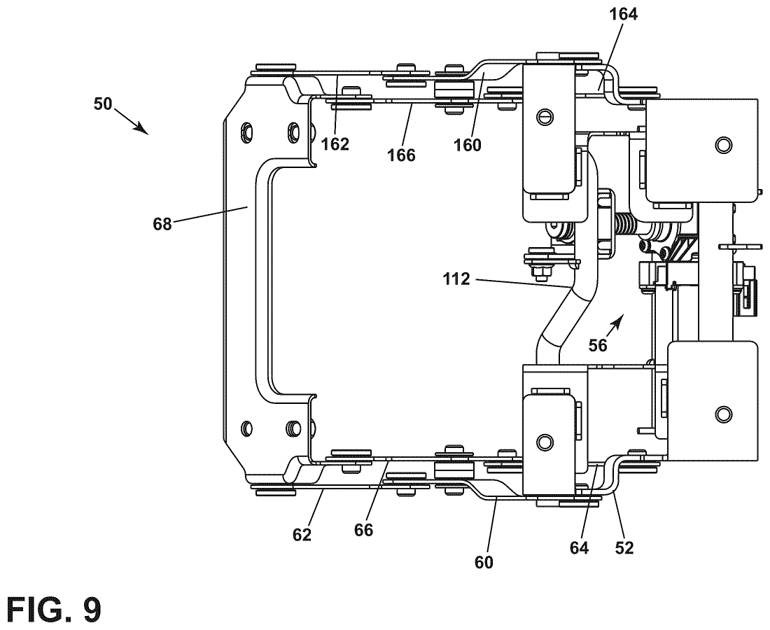

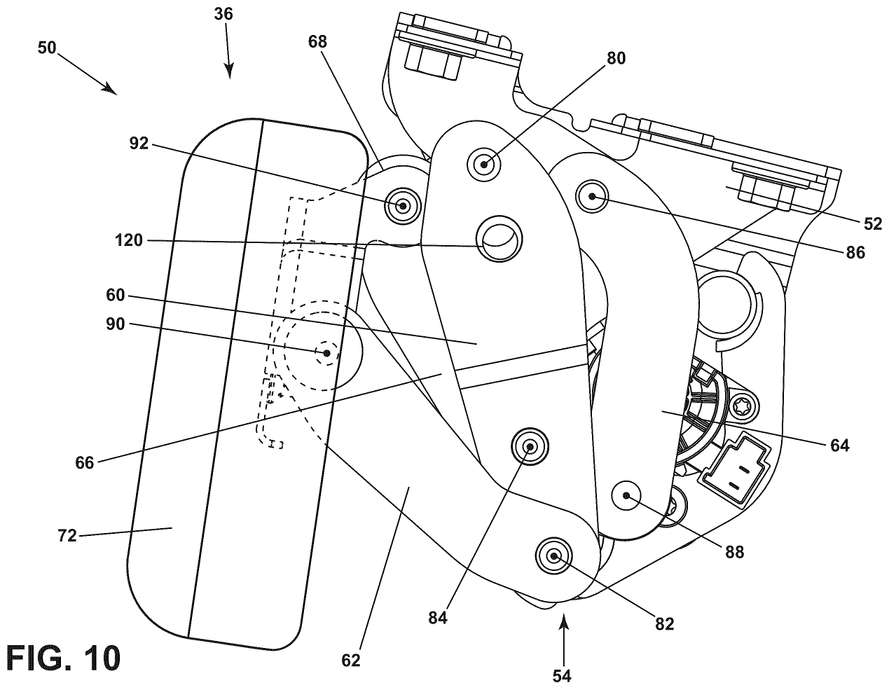

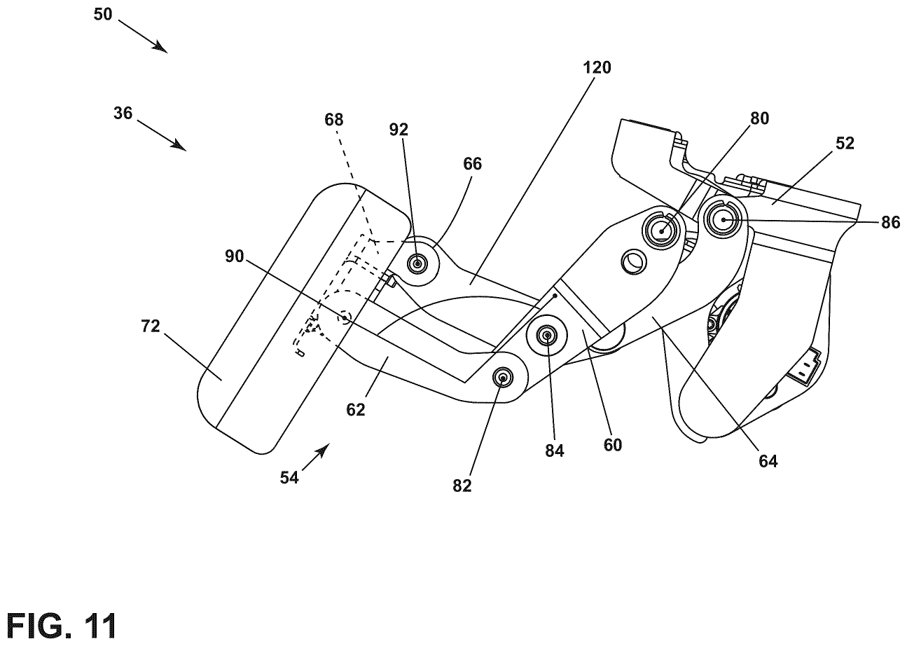

Example configurations of the seat portion adjuster 50 with the seat portion 36 disposed in a retracted position are generally illustrated in FIGS. 3-7. Example configurations of the seat portion adjuster 50 with the seat portion 36 disposed in an extended position are generally illustrated in FIGS. 8 and 9. Example configurations of the seat portion adjuster 50 with the seat portion disposed in a retracted position, an intermediate position, and an extended position are generally illustrated in FIGS. 10-12, respectively. To move the seat portion 36 toward the extended position, the actuator 56 can be operated, such as via a controller 42, to cause the cross member 70 and the first lever 60 to rotate such that the bottom of the first lever 60 moves generally forward and upward (e.g., clockwise in FIGS. 10-12). Such rotation of the first lever 60 causes the second lever 62 and the fourth lever 66 to move generally forward and upward. For example, rotation of the first lever 60 may move the second rotational axis 82 and the third rotational axis 84 forward and upward, which causes forward and upward movement of the second lever 62 and/or the fourth lever 66, which causes the seat portion bracket 68 and a cushion 72 connected thereto to move generally forward and upward toward the extended position. As the seat portion bracket 68 moves forward and upward, the seat portion bracket 68 may rotate relative to the second lever 62 about the sixth rotational axis 90 and/or relative to the fourth lever 66 about the seventh rotational axis 92 toward a more horizontal configuration.

To move the seat portion 36 toward the retracted position, the actuator 56 can be operated, such as via the controller 42, to cause the cross member 70 and the first lever 60 to rotate such that the bottom of the first lever 60 moves generally rearward and downward (e.g., counterclockwise in FIGS. 10-12). Such rotation of the first lever 60 causes the second lever 62 and the fourth lever 66 to move generally rearward and downward. For example, rotation of the first lever 60 may move the second rotational axis 82 and the third rotational axis 84 rearward and downward. Rearward and downward movement of the second lever 62 and/or the fourth lever 66 causes the seat portion bracket 68 and a cushion 72 connected thereto to move generally rearward and downward toward the retracted position. As the seat portion bracket 68 moves rearward and downward, the seat portion bracket 68 may rotate relative to the second lever 62 about the sixth rotational axis 90 and/or relative to the fourth lever 66 about the seventh rotational axis 92 toward a more vertical configuration.

A position (e.g., a rotational position) of the first lever 60 when the seat portion 36 is in the retracted position may be offset from a position of the first lever 60 when the seat portion 36 is in an extended position. The offset may, for example and without limitation, be at least 75 degrees, at least 85 degrees, at least 90 degrees, about 75 degrees to about 95 degrees, and/or other values.

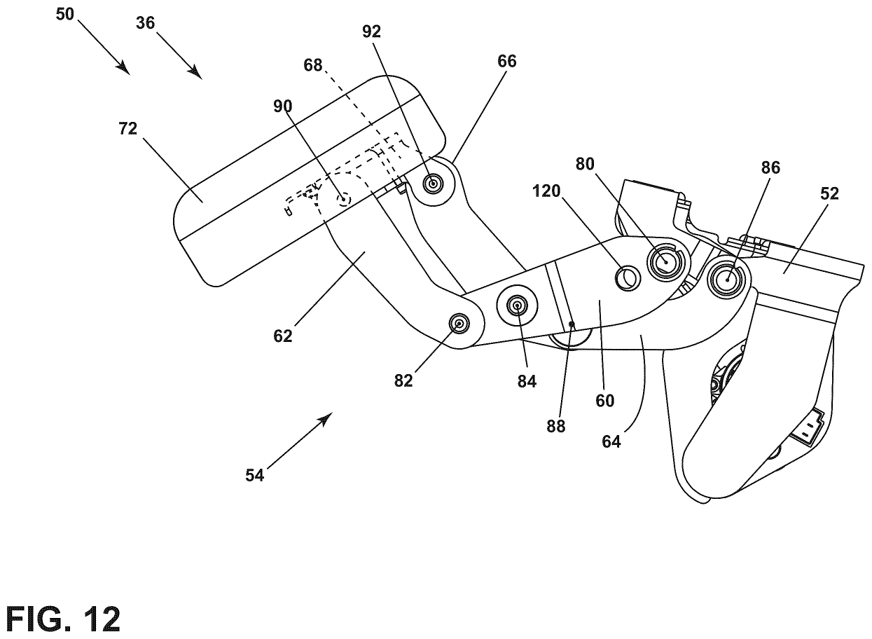

As the seat portion 36 moves, relative heights of the rotational axes 80-92 may change. For example, in a retracted position of the seat portion 36 (FIG. 10), the first rotational axis 80 may be disposed at a greater height than some or all of the axes 82-92, the fourth rotational axis 86 and the seventh rotational axis 92 can be disposed at substantially the same height and at a greater height than the sixth rotational axis 90, which can be disposed at a greater height than the third rotational axis 84, which may be disposed at a greater height than the fifth rotational axis 88, which may be disposed at a greater height than the second rotational axis 82. In an extended position of the seat portion 36 (FIG. 12), the sixth rotational axis 90 and the seventh rotational axis 92 may disposed at a greater height than the first rotational axis 80. Additionally or alternatively, in the extended position, the height of the second rotational axis 82 may be closer to the height of third rotational axis 84, and/or the height of the sixth rotational axis 90 may be closer to the height of the seventh rotational axis 92. For example and without limitation, in an extended position, heights of the second and third rotational axes 82, 84 may be within 15 mm, and/or heights of the sixth and seventh rotational axes 90, 92 may be within 15 mm. In contrast, in the retracted position, heights of the second and third rotational axes 82, 84 may be separated by at least 30 mm, and/or heights of the sixth and seventh rotational axes 90, 92 may be separated by at least 40 mm, for example and without limitation.

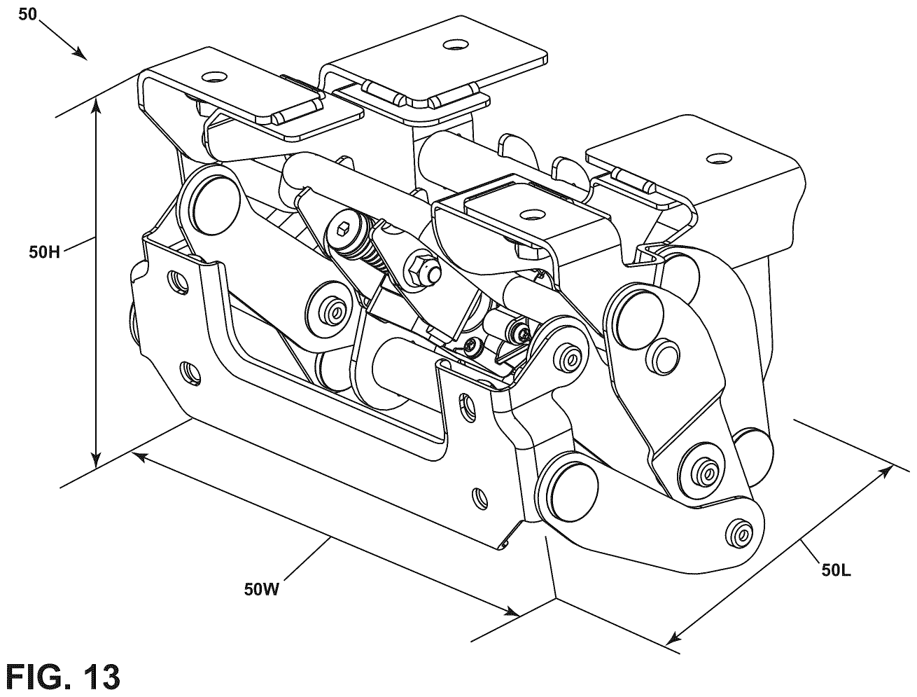

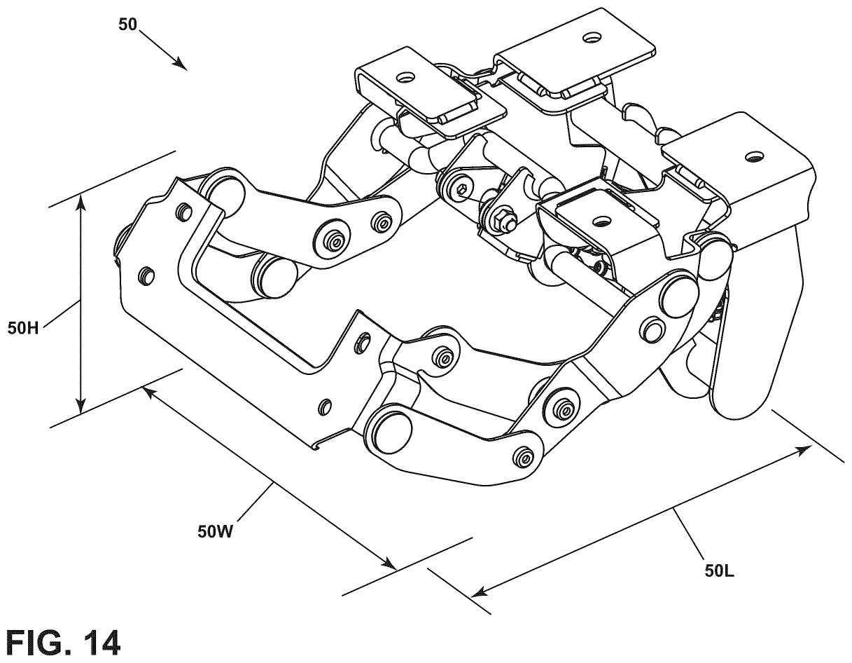

As generally illustrated in FIGS. 13 and 14, embodiments of seat portion adjusters 50 may be more compact than other designs, and include smaller lengths (e.g., in a forward/rearward direction) and/or smaller heights (e.g., in a vertical direction) for a given width (e.g., in lateral/transverse direction). For example and without limitation, in the retracted position (FIG. 13), a total length 50L of the seat portion adjuster 50 may be 70% or less of that a total width 50W of the seat portion adjuster 50. Additionally or alternatively, in the retracted position, a total height 50H of the seat portion adjuster 50 may be 70% or less of that the total width 50W of the seat portion adjuster 50. In a non-limiting example, in the retracted position, the total length 50L may be between about 150 mm and 175 mm, the total height 50H may be between about 155 mm and 180 mm, and/or the total width 50W may be between about 240 mm and 260 mm. In a non-limiting example configuration, a volume of a rectangular prism encompassing the seat portion adjuster 50 may be less than 6800 cm³ with a width 50W of at least 240 mm. A compact configuration may allow for seat portion adjusters 50 to be added and/or retrofitted to a wider range of existing seat designs.

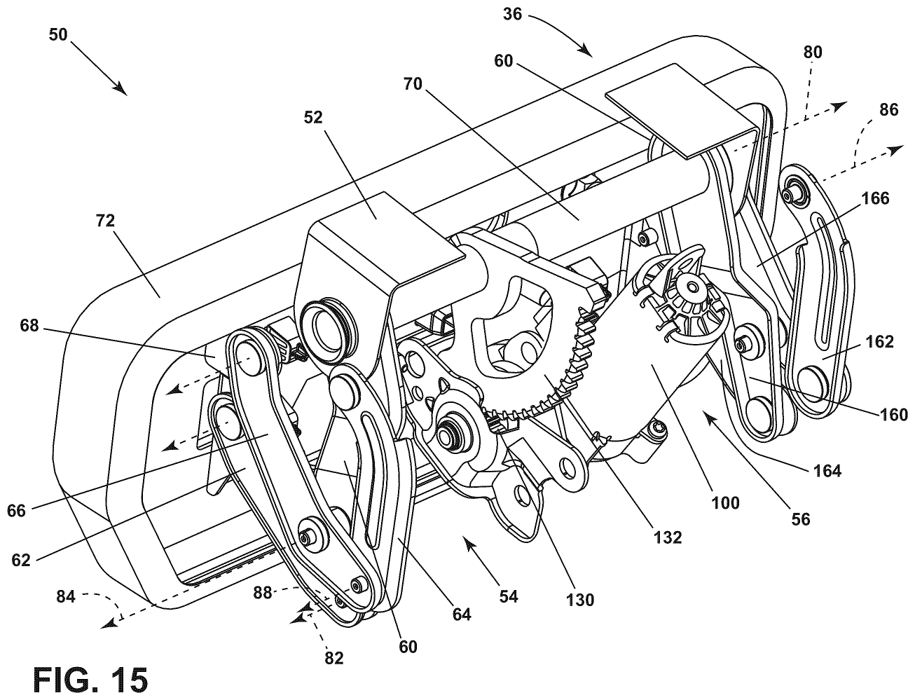

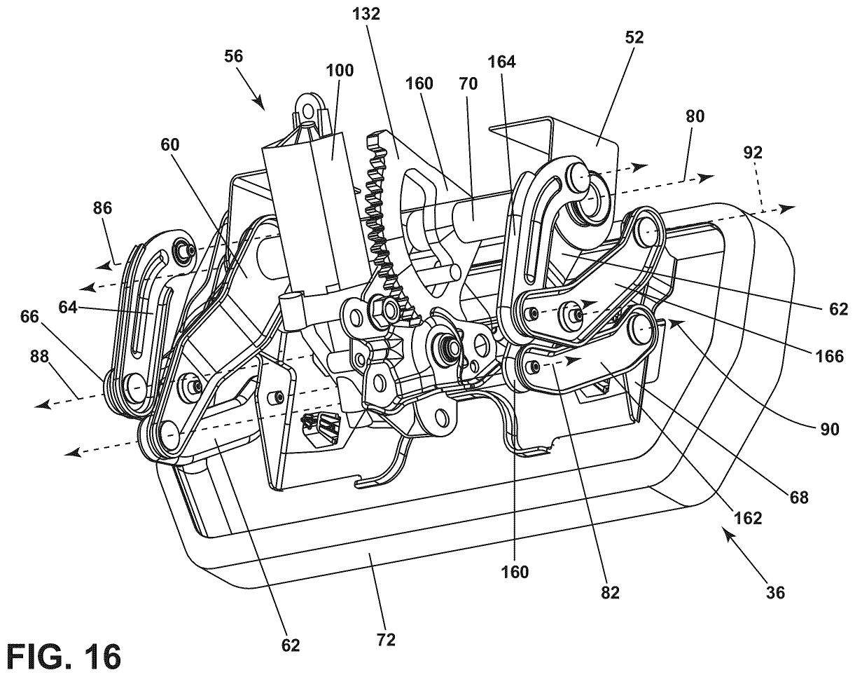

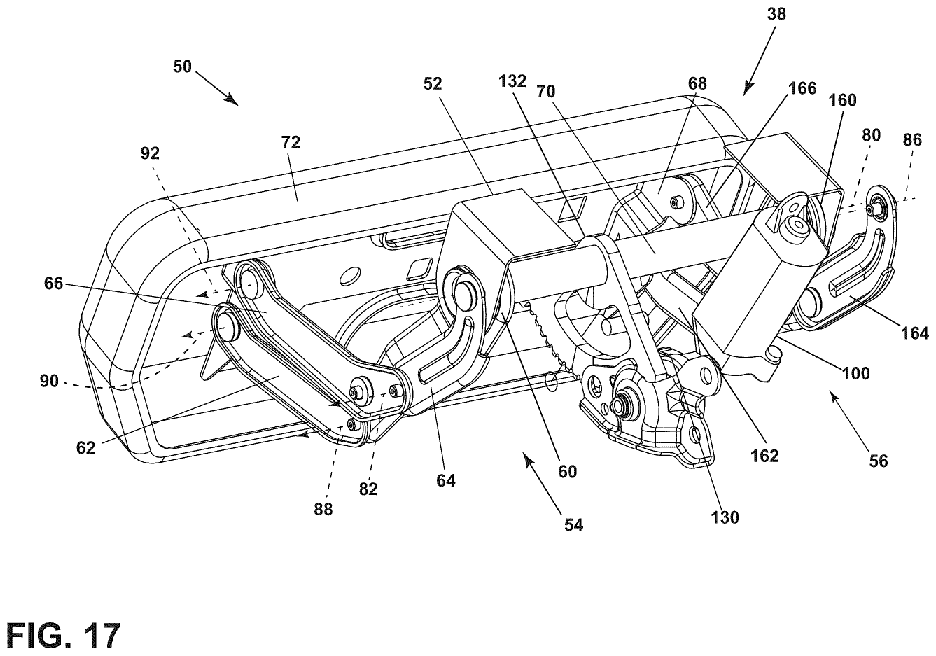

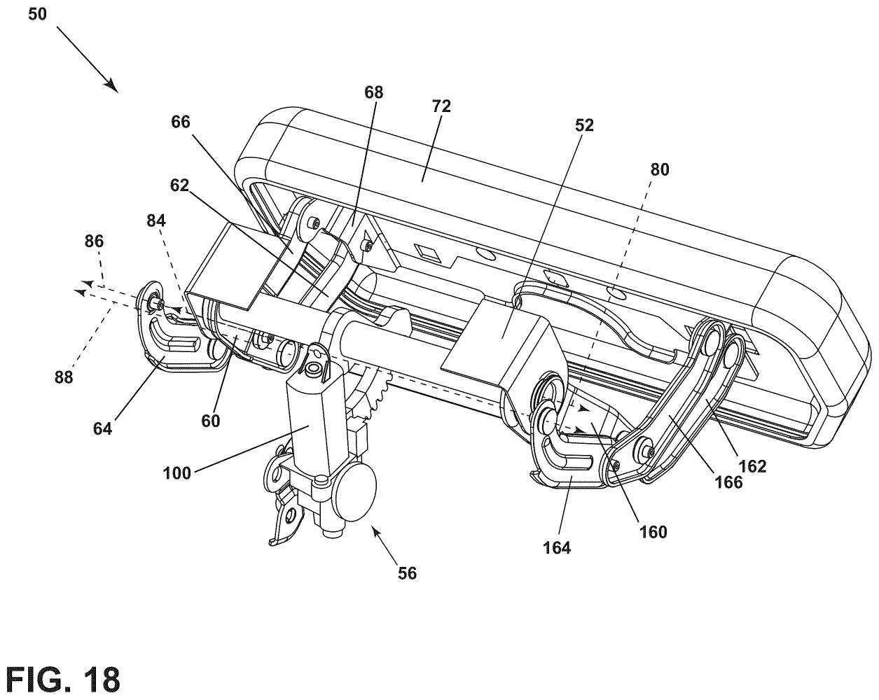

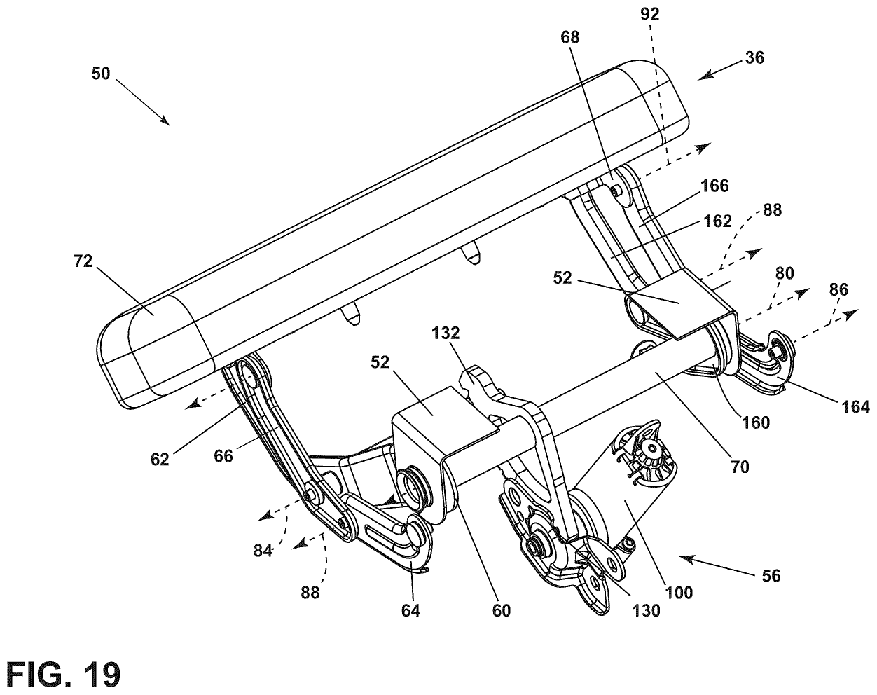

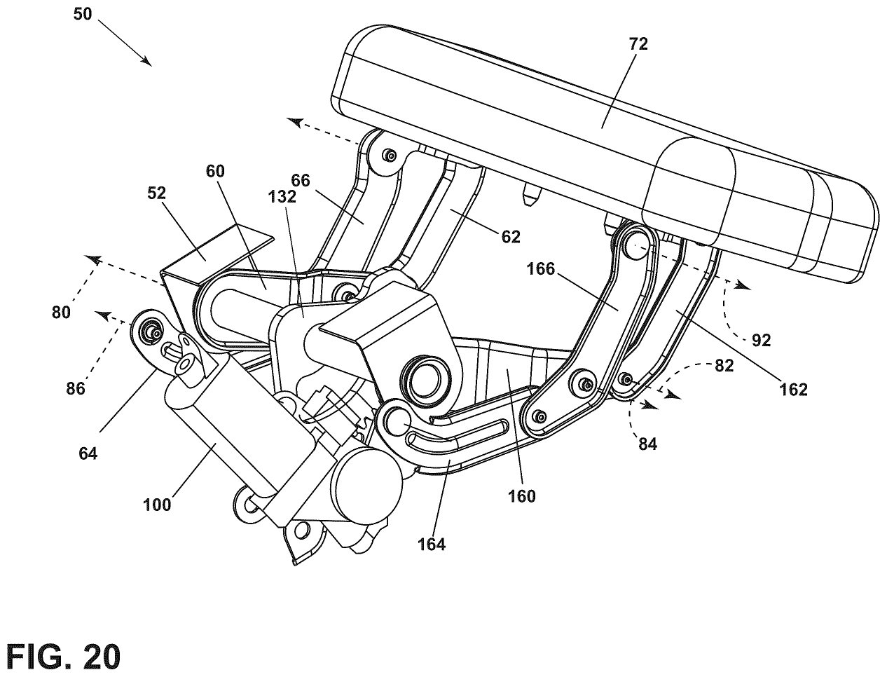

As generally illustrated in FIGS. 15-20, the actuator 56 of the seat portion adjuster 50 can include the motor 100 and a pinion 130 that may be operably coupled to the motor 100. The motor 100 may be connected (e.g., fixed) to the bracket 52. The seat portion adjuster 50 may include a sector gear 132 that may be fixed to the cross member 70 and engaged with the pinion 130 such that rotation of the pinion 130 causes rotation of the sector gear 132 and the cross member 70. The seat portion adjuster 50 can, for example, include the pinion 130 and the sector gear 132 instead of the threaded rod 102 and the nut 104. The cross member 70 may be connected (e.g., fixed) to the first lever 60 such that the cross member 70 and the first levers 60, 160 rotate about the first rotational axis 80 and/or such that the first levers 60, 160 are rotatably coupled to the bracket 52 via the cross member 70. For example, the cross member 70 may not be separately connected to the first lever 60 (e.g., at a first lever portion 120). Upon actuation of the motor 100, the pinion 130 may rotate, causing rotation of the sector gear 132, the cross member 70, and the first lever 60 about the first rotational axis 80. Rotation of the first lever 60 may then cause rotation of the levers 62-66, as described above, to move the seat portion bracket 68 and/or the seat portion 36 to and/or toward a retracted position or an extended position.

The second linkage 55, including the second linkage levers 160-166, may be configured and/or operate in the same or a similar manner as levers 60-66, respectively, of the first linkage 54, and may be connected to a second/opposite side of the bracket 52. The levers 60-66 and the levers 160-166 may have mirrored configurations.

In some configurations, the bracket 52 may include portions 140 (FIG. 3) disposed at opposite sides of the seat portion adjuster 50 and that may or may not be separate components. The portions 140 may be connected by a cross member 70.

In some configurations, the second levers 62, 162 and the third levers 64, 164 may have a common configuration (e.g., the same shape).

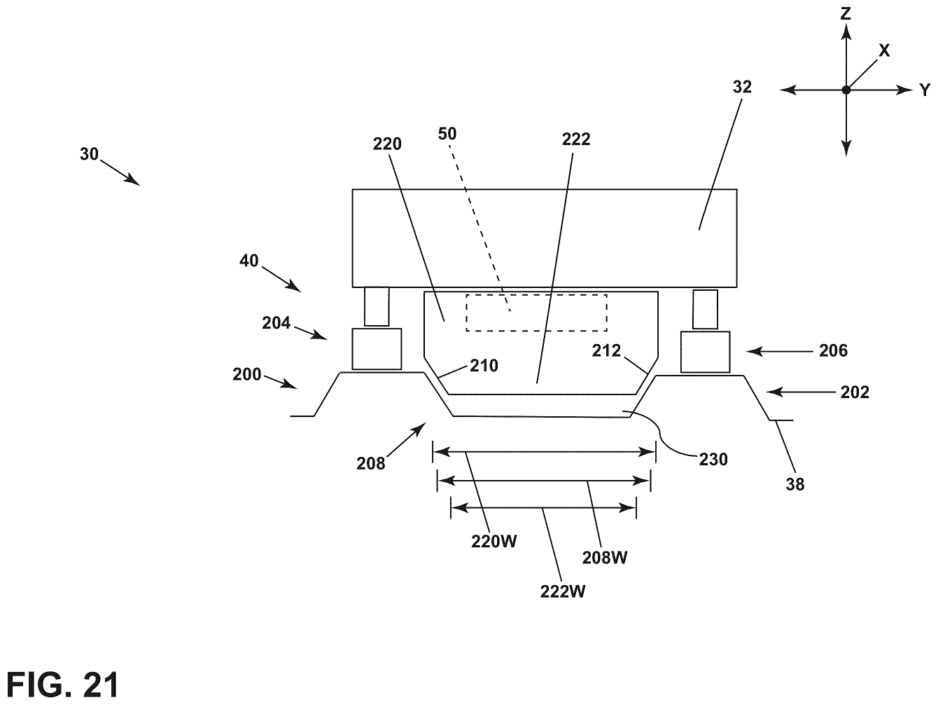

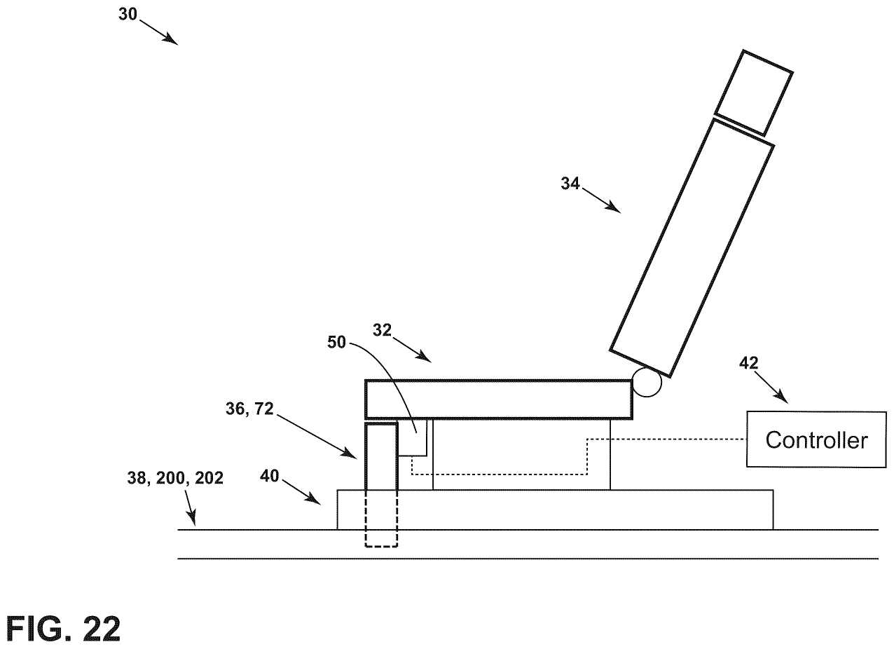

Referring to FIGS. 21 and 22, the seat assembly 30 including the seat base 32 coupled to the track assembly 40 connected to a mounting surface 38 is generally illustrated. The mounting surface 38 may include a pair of raised portions 200, 202 separated (e.g., in the lateral direction Y) by a lower portion 208. The track assembly 40 may include a first track 204 mounted to the first raised portion 200 and a second track 206 mounted to the second raised portion 202. The lower portion 208 may include tapered sides that extend up to the raised portions 200, 202. The seat portion 36 may include a cushion or bun 72 that may include recesses 210, 212 that correspond to and/or receive a portion of the track assembly 40 and/or a portion of the mounting surface 38 (e.g., tapered sides of raised portions 200, 202). For example and without limitation, the cushion 72 may include a trapezoidal configuration, and/or the recesses 210, 212 may include triangular configurations, among other configurations. In some examples, the cushion 72 includes a first portion 220 and a second portion 222. The first portion 220 may have a width 220W that is wider than a width 208W of the lower portion 208 (e.g., may overlap with tops of the raised portions 200, 202 in a vertical direction). The second portion 222 may have a width 222W that is not as wide as the width 208W of the lower portion 208. The second portion 222 may be disposed at least partially between the pair of raised portions 200, 202 (e.g., between the tapered sides of the lower portion 208) when the seat portion 36 is in a retracted position. The cushion 72 (e.g., the second portion 222) may extend into a channel 230 formed by the lower portion 208 and the raised portions 200, 202. Such a configuration may allow for the cushion 72 to have a greater surface area for supporting the legs of an occupant, such as compared to designs that do not include the second portion 222 and/or do not extend into the channel 230.

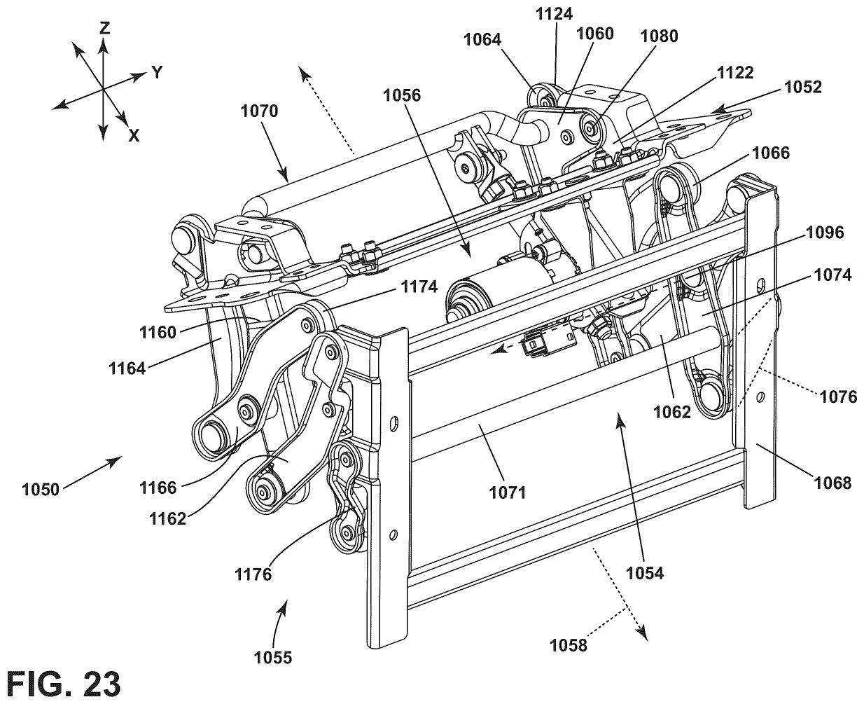

Referring to FIGS. 23-26, a seat portion adjuster 1050, which can be utilized with the seat assembly 30 (FIG. 1), is illustrated in a retracted position. The seat portion adjuster 1050 includes a bracket 1052, a first linkage 1054, a second linkage 1055, an actuator 1056, a centerline 1058, a first cross member 1070, and/or a second cross member 1071. The centerline 1058 extends through the center of the seat portion adjuster 1050 and is parallel with the longitudinal direction X. The bracket 1052 couples the seat portion adjuster 1050 to the seat base 32 (FIG. 1). The seat portion adjuster 1050 includes a seat portion bracket 1068 that couples with the seat portion 36 (FIG. 1).

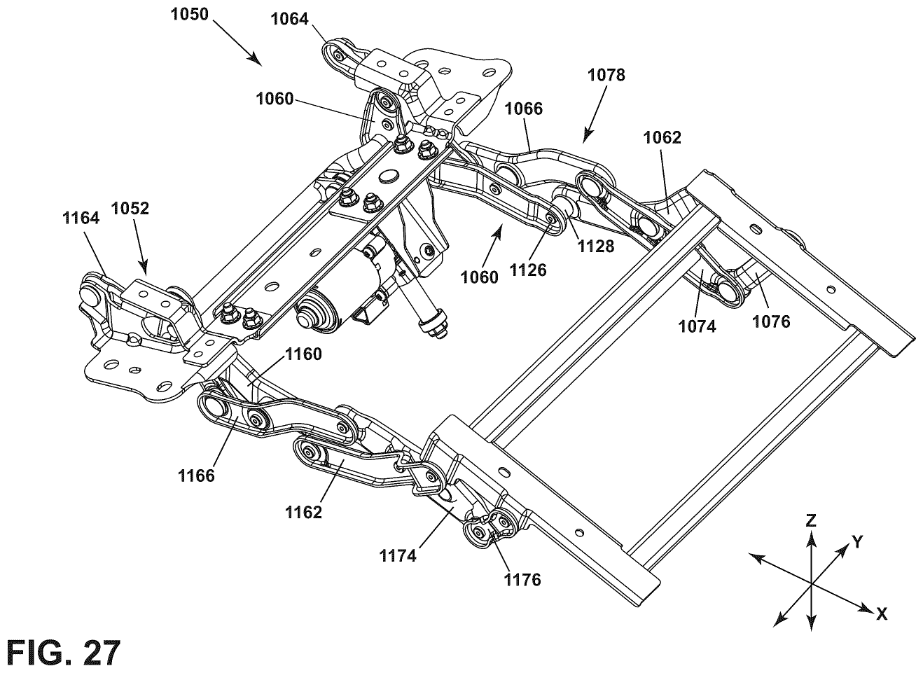

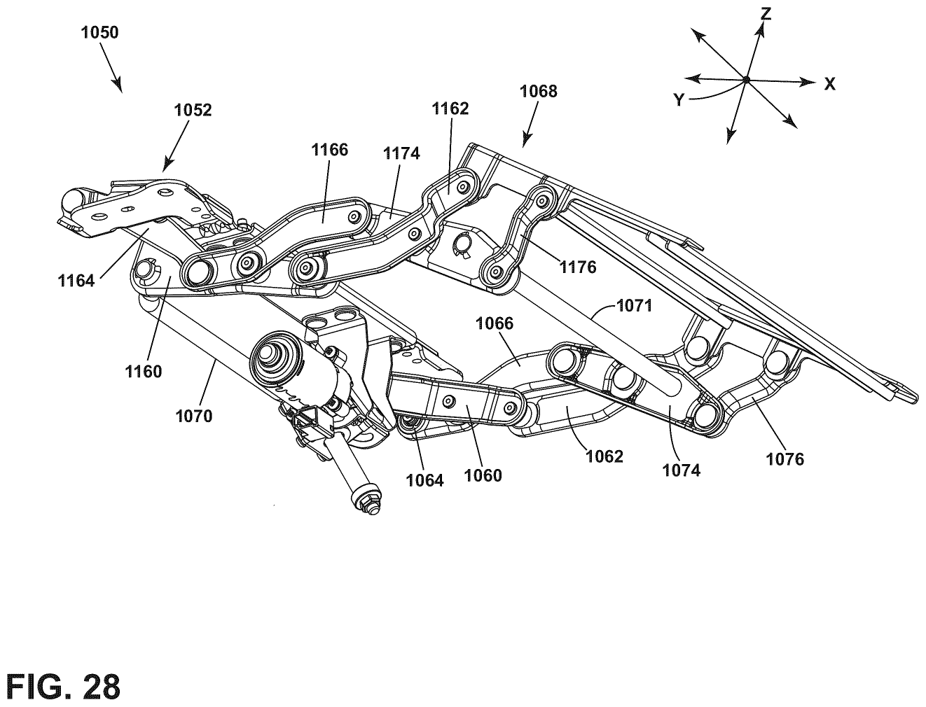

The first linkage 1054 includes a first lever 1060, a second lever 1062, a third lever 1064, a fourth lever 1066, a fifth lever 1074, and a sixth lever 1076. The second linkage 1055 includes a second linkage first lever 1160, a second linkage second lever 1162, a second linkage third lever 1164, a second linkage fourth lever 1166, a second linkage fifth lever 1174, and/or a second linkage sixth lever 1176. The second levers 1062, 1162 and the sixth levers 1076, 1176 are rotatably coupled to the seat portion bracket 1068. For example, the first linkage 1054 and/or the second linkage 1055 movably couples the seat portion 36 (FIG. 1) to the seat base 32 (FIG. 1) such that the seat portion 36 can move between the retracted position (FIGS. 23-26) and an extended position (FIGS. 27-29). The bracket 1052 includes a first section 1122 and a second section 1124 offset from the first section 1122 (e.g., in the lateral direction Y, the longitudinal direction X, and/or the vertical direction Z). The first lever 1060 is rotatably coupled to the first section 1122 at a first rotational axis 1080 that is fixed relative to the bracket 1052. In the example illustrated in FIG. 23, the first section 1122 is laterally inward of (e.g., closer to the centerline 1058 than) the second section 1124.

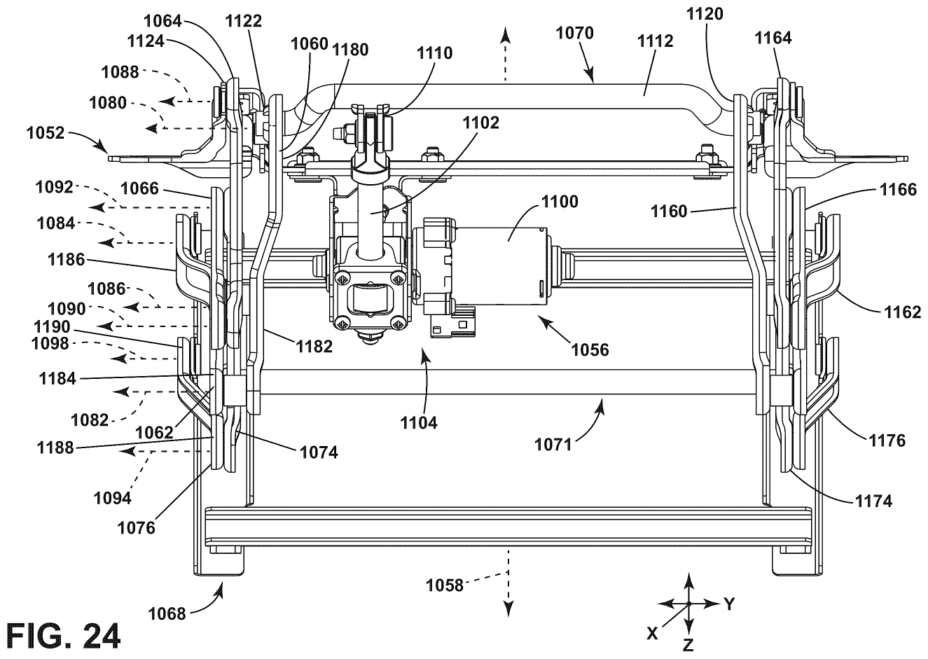

Referring to FIG. 24, the first lever 1060 is rotatably coupled to the second lever 1062 at a second rotational axis 1082 that moves relative to the bracket 1052 (e.g., rotates about the first rotational axis 1080). The first rotational axis 1080 and the second rotational axis 1082 are disposed at opposite ends of the first lever 1060. The second lever 1062 is rotatably coupled to the seat portion bracket 1068 at a third rotational axis 1084. The first lever 1060 is rotatably coupled to the fourth lever 1066 at a fourth rotational axis 1086. The first cross member 1070 is connected (e.g., fixed) to the first lever 1060.

The third lever 1064 is rotatably coupled to the second section 1124 of the bracket 1052 at a fifth rotation axis 1088 and rotatably coupled to the fourth lever 1066 at a sixth rotational axis 1090. The fifth rotational axis 1088 is fixed relative to the bracket 1052. The sixth rotational axis 1090 moves relative to the bracket 1052 (e.g., rotates about the fifth rotational axis 1088). The fourth lever 1066 is rotatably coupled to the fifth lever 1074 at a seventh rotational axis 1092. The sixth and seventh rotational axes 1090, 1092 are disposed at opposite ends of the fifth lever 1074 with the fourth rotational axis 1086 therebetween.

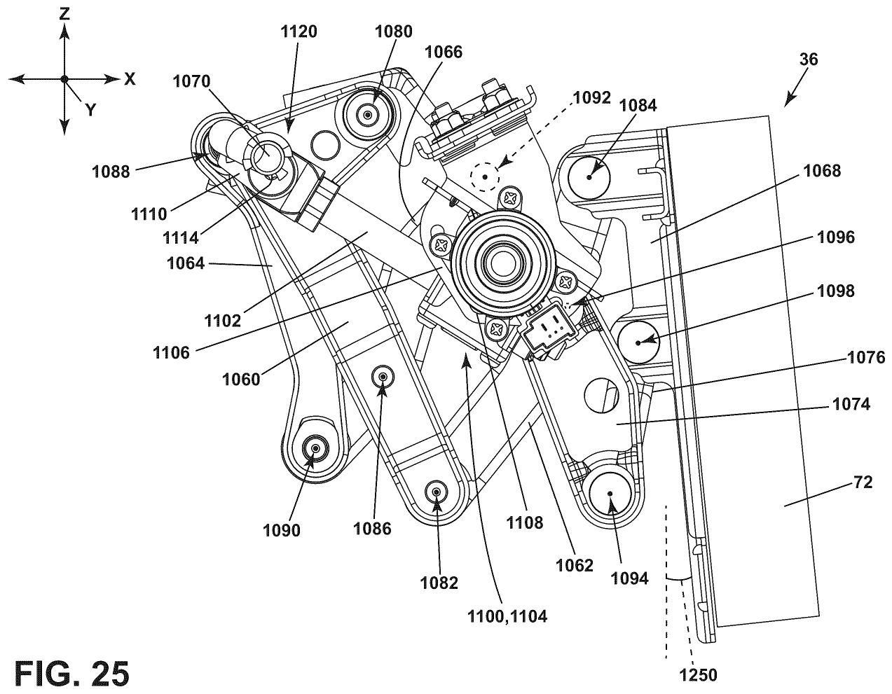

The fifth lever 1074 is rotatably coupled to the sixth lever 1076 at an eighth rotational axis 1094. The fifth lever 1074 is also rotatably coupled to the second lever 1062 at a ninth rotational axis 1096 (FIG. 23). The seventh rotational axis 1092 and the eighth rotational axis 1094 are disposed at opposite ends of the fifth lever 1074 with the ninth rotational axis 1096 disposed therebetween. The sixth lever 1076 is rotatably coupled to the seat portion bracket 1068 at a tenth rotational axis 1098. The third rotational axis 1084 and the tenth rotational axis 1098 are fixed relative to the seat portion bracket 1068 and move relative to the bracket 1052. The third rotational axis 1084 and the tenth rotational axis 1098 are offset from each other in at least one direction (e.g., the vertical direction Z in the retracted position-FIG. 25). The axes 1080-1098 are parallel with each other and the lateral direction Y.

The first lever 1060 includes a first section 1180 and a second section 1182 offset from the first section 1180 in the lateral direction Y. For example, the first section 1180 can be parallel with a first X-Z plane and the second section 1182 can be parallel to a second X-Z plane offset outward in the lateral direction Y from the first X-Z plane (e.g., the second section 1182 is disposed farther from the centerline 1058 than the first section 1180). The first section 1180 is rotatably coupled to the bracket 1052. The second section 1182 is laterally outward of the first section 1180 and rotatably coupled to the second lever 1062 and/or the fourth lever 1066.

The second lever 1062 includes a first section 1184 and a second section 1186, and the sixth lever 1076 includes a first section 1188 and a second section 1190. The second section 1186 of the second lever 1062 is offset from the first section 1184 in the lateral direction Y such that the first section 1184 is closer to the centerline 1058 of the seat portion adjuster 1050 than the second section 1186. The second section 1190 of the sixth lever 1076 is offset from the first section 1188 in the lateral direction Y such that the first section 1188 is closer to the centerline 1058 of the seat portion adjuster 1050 than the second section 1190.

Some of the levers 1060-1068, 1074, 1076 and/or sections thereof can be at least partially coplanar. For example, at least portions of the third lever 1064 and the fifth lever 1074 can be coplanar, which can include being disposed such that an X-Z plane extends through some or most of the third lever 1064 and the fifth lever 1074. Additionally or alternatively, at least portions of the fourth lever 1066, the first section 1184 of the second lever 1062, and/or the first section 1188 of the sixth lever 1076 can be coplanar, which can include being disposed such an X-Z plane extends through some or most of the fourth lever 1066, the first section 1184, and the first section 1188. Additionally or alternatively, at least portions of the second section 1186 of the second lever 1062 and the second section 1190 of the sixth lever 1076 can be coplanar, which can include being disposed such that an X-Z plane extends through some or most of the second sections 1186, 1190.

Referring to FIGS. 24 and 25, the actuator 1056 includes a motor 1100, a threaded rod 1102, and/or a transmission 1104 engaged with the threaded rod 1102 such that operation of the motor 1100 causes relative movement between the motor 1100 and the threaded rod 1102, such as translational movement of the threaded rod 1102 through the transmission 1104. The motor 1100 is coupled to the bracket 1052 via a motor bracket 1106 connected (e.g., fixed) to the bracket 1052. The motor 1100 is coupled to the motor bracket 1106 such that translational movement of the motor 1100 is restricted or prevented, but rotation of the motor 1100 about a motor rotational axis 1108 relative to the bracket 1052 and the motor bracket 1106 is permitted, at least to some degree. The motor rotational axis 1108 is parallel with the lateral direction Y. The threaded rod 1102 is coupled (e.g., rotatably coupled) to a flange 1110 at a rod rotational axis 1114 that can be parallel with the lateral direction Y. The threaded rod 1102 is coupled to the flange 1110 such that the threaded rod 1102 does not rotate about its longitudinal axis that is parallel to an X-Z plane. The flange 1110 is connected (e.g., fixed) to the first cross member 1070, which operably couples the motor 1100 to the first linkage 1054 and the second linkage 1055. The cross member 1070 can include an offset portion 1112 that is radially offset from a central axis of the cross member 1070. The offset portion 1112 may, for example, provide the cross member 1070 with a generally C-shaped configuration. The flange 1110 may be fixed to the cross member 1070, such as to the offset portion 1112. The threaded rod 1102 is coupled (e.g., rotatably) to the flange 1110 such that actuation of the motor 1100 causes rotation of the cross member 1070.

The cross member 1070 is coupled with the first lever 1060 such that rotation of the cross member 1070, such as via the actuator 1056, causes rotation of the first lever 1060 about the first rotational axis 1080. In some configurations, the cross member 1070 is connected to a first lever portion 1120 of the first lever 1060 that is offset from the first rotational axis 1080, the second rotational axis 1082, and/or the fourth rotational axis 1086.

Rotation of the first lever 1060 causes (e.g., directly) movement, such as rotation and translation, of second lever 1062 and the fourth lever 1066. Movement of the second lever 1062 and/or the fourth lever 1066 causes movement of the fifth lever 1074, such as translation and rotation. Movement of the fourth lever 1066 also causes movement of the third lever 1064. Movement of the fifth lever 1074 causes movement of the sixth lever 1076, such as translation and rotation. Movement of the second lever 1062 and the sixth lever 1076 causes movement (e.g., rotation and translation) of the seat portion bracket 1068, such as to or toward the retracted position or the extended position.

The second linkage 1055 (FIG. 24) can be configured in a similar manner as the first linkage 1054 and can, for example, included a mirrored version of the first linkage 1054. For example, the second linkage first lever 1160, the second linkage second lever 1162, the second linkage third lever 1164, the second linkage fourth lever 1166, the second linkage fifth lever 1174, and the second linkage sixth lever 1176 can have the mirrored configurations of and be rotatably coupled in the same manner as the first lever 1060, the second lever 1062, the third lever 1064, the fourth lever 1066, the fifth lever 1074, and the sixth lever 1076, respectively. The second linkage first lever 1160 can be connected (e.g., fixed) with the first cross member 1070 such that operation of the motor 1100 also causes rotation of the second linkage first lever 1160, which can cause movement (e.g., rotation and/or translation) of the other second linkage levers 1162, 1164, 1166, 1174, 1176.

The first linkage 1054 is connected to a first lateral side of the seat portion bracket 1068 and the second linkage 1055 (FIG. 24) is connected to a second lateral side of the seat portion bracket 1068. Optionally, operation of the actuator 1056 can cause simultaneous and/or synchronized operation of the first and second linkages 1054, 1055 such that movement of the seat portion bracket 1068 is caused by both linkages 1054, 1055. Movement of the first linkage 1054 and the second linkage 1055 is synchronized, at least in part, by the first cross member 1070 connected (e.g., fixed) to the first levers 1060, 1160, and/or by the second cross member 1071, which is connected (e.g., fixed) to the fifth levers 1074, 1174. Central axes of the cross members 1070, 1071 are parallel to the lateral direction Y.

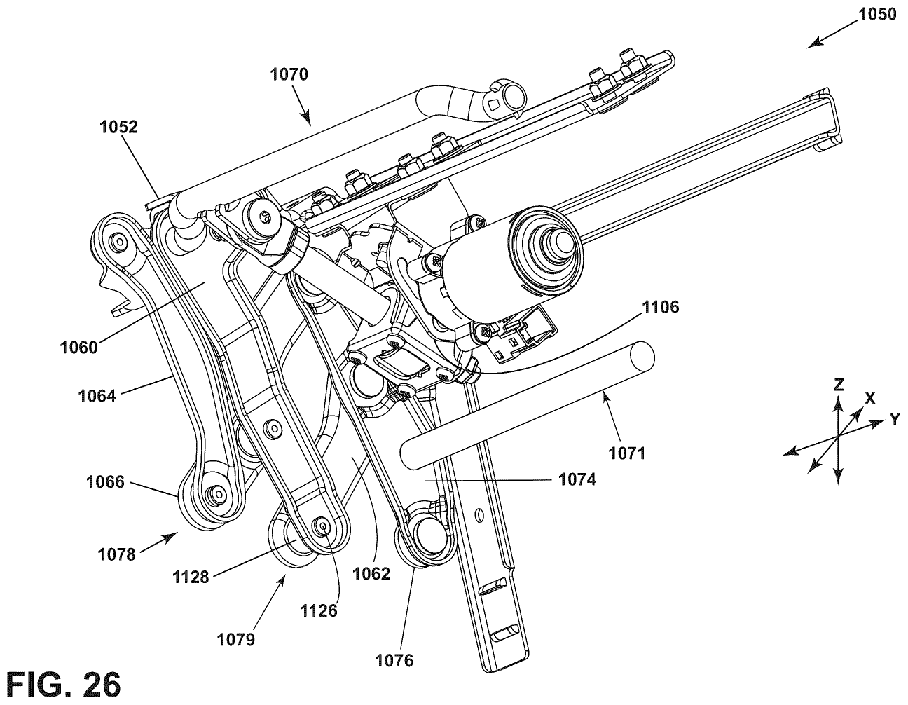

Referring to FIGS. 26-28, the third, fourth, fifth, and sixth levers 1064, 1066, 1074, 1076 can form a first arm 1078, and the first and second levers 1060, 1062 can form a second arm 1079. The first and second arms 1078, 1079 can be interconnected and/or interlaced. For example, the first arm 1078 can be connected to the second arm 1079 via the rotatable coupling between the first lever 1060 and the fourth lever 1066 and/or via the rotatable coupling between the second lever 1062 and the fifth lever 1074. An interlaced configuration can include the second arm 1079 disposed partially laterally outward of the first arm 1078 and partially laterally inward of the first arm 1078. For example, the first lever 1060 can be laterally inward of the first arm 1078 and can be rotatably connected to the second lever 1062 via a rivet 1126 that includes a lateral spacer portion 1128, and at least some, most, or all of the second lever 1062 can be laterally outward of (e.g., farther from the centerline 1058 than) the third lever 1064. In the extended position shown in FIG. 27, at least some of the rivet 1126, such as at least some of the lateral spacer portion 1128, can be directly below the fourth lever 1066 in the vertical direction Z. Additionally or alternatively, the second section 1186 of the second lever 1062 can be laterally outward of the fourth lever 1066 and/or the fifth lever 1074. The lateral separation between levers and portions thereof can limit interference between the levers to facilitate retraction of the seat portion 36 and limit the size of the seat portion adjuster 1050 in the retracted position.

Referring to the retracted and extended positions shown in FIGS. 23-26 and FIGS. 27-29, respectively, moving the seat portion 36 toward the extended position via the seat portion adjuster 1050 can include operating the actuator 1056, such as by operating the motor 1100 via the controller 42 (FIG. 1), to cause movement of the threaded rod 1102, which causes rotation of the first cross member 1070, which causes rotation of the first lever 1060 and the second linkage first lever 1160 (e.g., counterclockwise in FIG. 25). Such rotation of the first levers 1060, 1160 causes, at least indirectly, rotation of the third levers 1064, 1164 about the fifth rotational axis 1088 (e.g., counterclockwise), rotation and translation of the second levers 1062, 1162 (e.g., clockwise rotation; forward and upward translation), rotation and translation of the fourth levers 1066, 1166 (e.g., clockwise rotation; forward and upward translation), rotation and translation of the fifth levers 1074, 1174 (e.g., counterclockwise rotation; forward and upward translation), rotation and translation of the sixth levers 1076, 1176 (e.g., clockwise rotation; forward and upward translation), and rotation and translation of the seat portion bracket 1068 (e.g., counterclockwise rotation; forward and upward translation). Moving the seat portion 36 toward the retracted position via the seat portion adjuster 1050 can include conducting the reverse operation, such as by operating the motor 1100 in the opposite direction to cause rotation of the first cross member 1070 and the first levers 1060, 1160 in the opposite direction (e.g., clockwise in FIG. 25).

The retracted and extended positions can have one or more of a variety of configurations. In some examples, such as generally illustrated in FIG. 25, in the retracted position, the seat portion 36 and/or the seat portion bracket 1068 can be generally vertical, which can include being within 15 degrees, within 10 degrees, or other values of vertical (e.g., angled at an angle 1250 of 15 degrees or less, or 10 degrees or less, relative to the vertical direction Z). Such a configuration may allow for some, most, or all of the seat portion 36 and/or the seat portion adjuster 1050 to be disposed under the seat base 32 (FIG. 1), and/or to limit the extent to which the seat portion 36 and/or the seat portion adjuster 1050 extend longitudinally beyond the seat base 32. In the retracted position, the first rotational axis 1080 can be disposed at a greater height (e.g., relative to the mounting surface 38—FIG. 1) than the fifth rotational axis 1088, which can be disposed at a greater height the third rotational axis 1084 and the seventh rotational axis 1092, which can be disposed at substantially the same height as each other and at a greater height the tenth rotational axis 1098, which can be disposed at a greater height the fourth rotational axis 1086, which can be disposed at a greater height the sixth rotational axis 1090, which can be disposed at a greater height than the second rotational axis 1082 and/or the eighth rotational axis 1094, which can be disposed at substantially the same height. In the retracted position, the motor rotational axis 1108 can be at a lower height than the third rotational axis 1084 and at a greater height than the tenth rotational axis 1098. Additionally or alternatively, the rod rotational axis 1114 can be disposed at substantially the same height as the third rotational axis 1084 and/or the seventh rotational axis 1092.

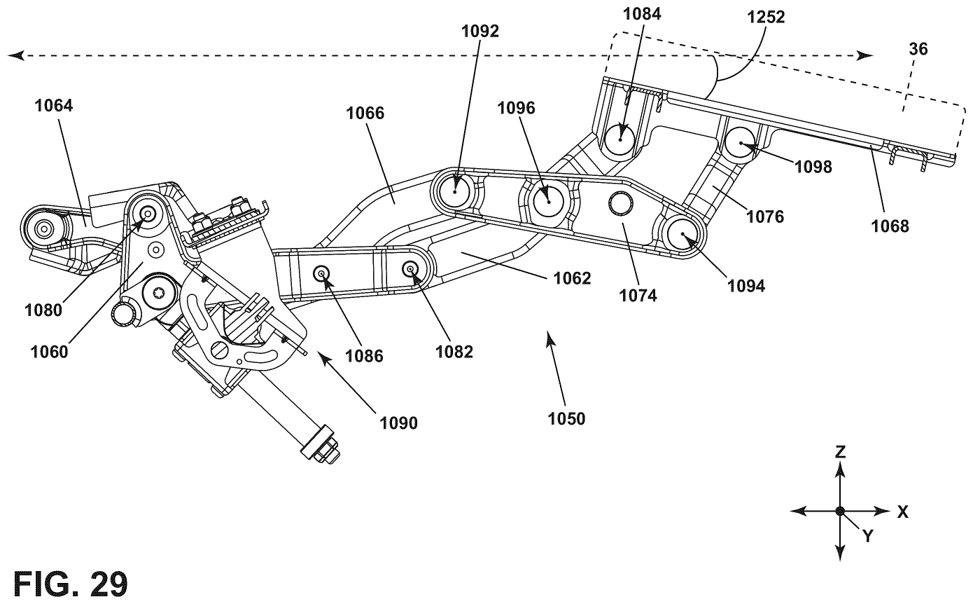

In some examples, such as generally illustrated in FIG. 29, in the extended position, the seat portion 36 and/or the seat portion bracket 1068 can be closer to horizontal, such as within 20 degrees, 15 degrees, or other values, of horizontal (e.g., angled at an angle 1252 of 20 degrees or less, 15 degrees or less, or other values, relative to the longitudinal direction X). Such a configuration can allow the seat portion 36 to provide an increased range of support (e.g., angles of the seat portion 36) to an occupant of the seat assembly 30 (FIG. 1), such as to the lower legs (e.g., calves) of the occupant. For example, the seat portion adjuster 1050 can rotate the seat portion 36 from a first angle (e.g., angle 1250) relative to vertical to a second angle (e.g., 90 degrees less angle 1252) and the difference between the first and second angles can be at least 70 degrees (e.g., 70 degrees to 90 degrees, 70 degrees to 80 degrees, or other values). Additionally or alternatively, the seat portion adjuster 1050 can move the seat portion 36 farther in the longitudinal direction X than at least some other designs. Additionally or alternatively, the seat portion adjuster 1050 may allow for using a seat portion 36 with an increased surface area relative to other designs, and/or the seat portion adjuster 1050 may be able to support a greater amount of weight than other designs.

With further reference to FIG. 29, in the extended position, the tenth rotational axis 1098 can be disposed at substantially the same or a greater height than the third rotational axis 1084, which can be disposed at a greater height than the seventh rotational axis 1092, the eighth rotational axis 1094, and/or the ninth rotational axis 1096, which can be disposed at substantially the same height as each other and/or at a greater height than the first rotational axis 1080, which can be disposed at a greater height than the fifth rotational axis 1088, which can be disposed at a greater height than the second rotational axis 1082, which be disposed at a greater height than the fourth rotational axis 1086, which can be disposed at a greater height than the sixth rotational axis 1090, which can be disposed at a greater height than the motor rotational axis 1108.

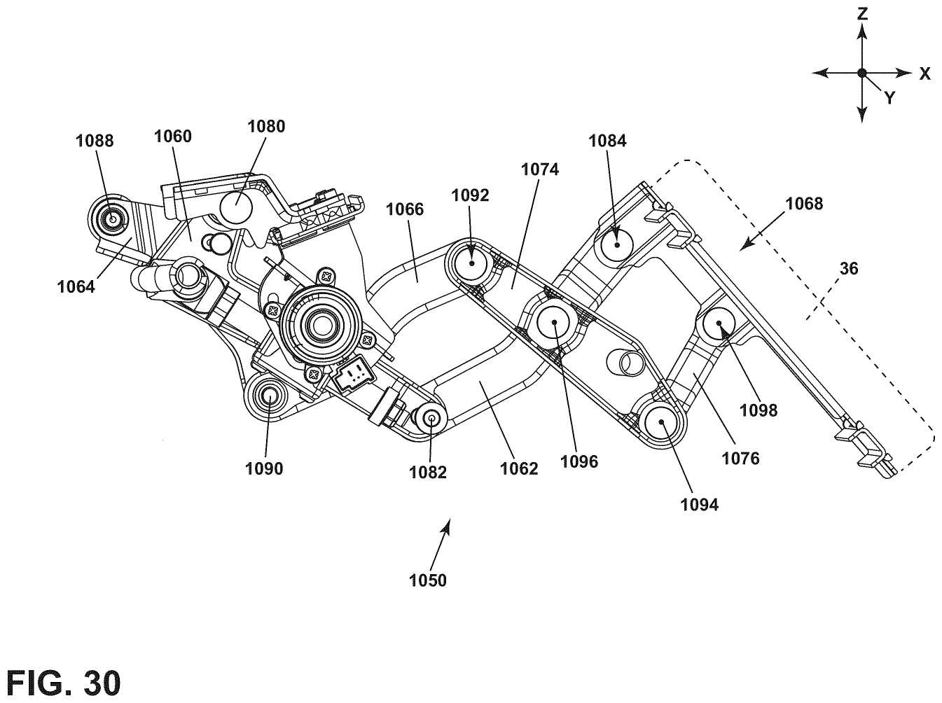

Referring to FIG. 30, the seat portion adjuster 1050 move the seat portion 36 to one or more intermediate positions between the retracted position and the extended position.

Rotatable couplings described herein can be provided in one or more of a variety of configurations. For example, rotatable couplings can be provided via pivots, rivets, bearings, bushings, or other components, and combinations thereof.

In some examples, a seat assembly 30 can include multiple seats, each with a seat base 32, a seat back 34 and a seat portion 36. The seats can each include a seat portion adjuster 50, 1050. In some examples, seats of the same seat assembly 30 can include the same or different seat portion adjusters. For example a first seat of the seat assembly 30 can include the seat portion adjuster 50 and a second seat of the seat assembly 30 can include the seat portion adjuster 1050.

The instant disclosure includes the following non-limiting embodiments:

A seat assembly, comprising: a seat base; a seat portion movably coupled to the seat base; and a seat portion adjuster coupled to the seat base and the seat portion, the seat portion adjuster including: a bracket connected to the seat base; a motor operably coupled to the bracket; and a linkage coupled to the seat portion, the bracket, and the motor, the linkage including a first lever, a second lever, a third lever, and a fourth lever; wherein the first lever is rotatably coupled to the bracket and the second lever, the third lever is rotatably coupled to the bracket, the second lever, and the fourth lever; and the second lever and the fourth lever are rotatably coupled to the seat portion.

The seat assembly of any preceding embodiment, wherein the linkage includes a fifth lever rotatably coupled to the second lever, and a sixth lever rotatably coupled to the fifth lever and the seat portion.

The seat assembly of any preceding embodiment, wherein the second lever is rotatably coupled to the seat portion via the fifth lever and the sixth lever.

The seat assembly of any preceding embodiment, wherein the linkage includes a seat portion bracket rotatably coupled to second lever and the sixth lever; and the seat portion includes a calf rest including a cushion connected to the seat portion bracket.

The seat assembly of any preceding embodiment, wherein the fifth lever is rotatably coupled to a middle section of the second lever.

The seat assembly of any preceding embodiment, wherein the third lever includes a third lever first section and a third lever second section laterally offset from the third lever first section.

The seat assembly of any preceding embodiment, wherein the fourth lever includes a fourth lever first section and a fourth lever second section laterally offset from the fourth lever first section; and the sixth lever includes a sixth lever first section and a sixth lever second section laterally offset from the sixth lever first section.

The seat assembly of any preceding embodiment, wherein the bracket includes a bracket first section and a bracket second section laterally outward of the bracket first section; the first lever is rotatably coupled to the bracket first section; the third lever first section is rotatably coupled to the bracket second section; the third lever second section is rotatably coupled to the fourth lever first section; and the fourth lever second section is rotatably coupled to the fifth lever.

The seat assembly of any preceding embodiment, wherein the seat portion adjuster includes a cross member operably coupled to the motor and the third lever first section such that operation of the motor rotates the third lever relative to the bracket.

The seat assembly of any preceding embodiment, wherein the bracket first section is disposed rearward of the bracket second section.

The seat assembly of any preceding embodiment, wherein the linkage is a first linkage; and the seat portion adjuster includes a second linkage including a second linkage first lever, a second linkage second lever, a second linkage third lever, and a second linkage fourth lever.

The seat assembly of any preceding embodiment, wherein the first linkage includes a first linkage fifth lever and a first linkage sixth lever; and the second linkage includes a second linkage fifth lever and a second linkage sixth lever.

The seat assembly of any preceding embodiment, wherein the seat portion adjuster includes a cross member connected to the first lever of the first linkage, the second linkage first lever, and the motor.

The seat assembly of any preceding embodiment, wherein the cross member includes an offset portion; and the motor is coupled to the offset portion.

The seat assembly of any preceding embodiment, wherein the first linkage includes a first linkage fifth lever and a first linkage sixth lever; the second linkage includes a second linkage fifth lever and a second linkage sixth lever; and the seat portion adjuster includes a second cross member connected to the first linkage fifth lever and the second linkage fifth lever.

The seat assembly of any preceding embodiment, wherein the seat portion has an extended position in which the seat portion is disposed at a first angle and a retracted position in which the seat portion is disposed at a second angle; and a difference between the first angle and the second angle is at least 50 degrees.

The seat assembly of any preceding embodiment, wherein the difference is at least 70 degrees.

The seat assembly of any preceding embodiment, wherein, in the retracted position, the seat portion is within 10 degrees of vertical.

The seat assembly of any preceding embodiment, wherein, in the extended position, the seat portion is within 20 degrees of horizontal.

The seat assembly of any preceding embodiment, wherein the seat portion has an extended position and a retracted position; the linkage includes a fifth lever and a sixth lever; the second lever is rotatably coupled to the seat portion at a seat portion first axis; the sixth lever is rotatably coupled to the seat portion at a seat portion second axis; the seat portion first axis is disposed at a greater height than the seat portion second axis when the seat portion is in the retracted position; and the seat portion first axis is disposed at lower height than and rearward of the seat portion second axis when the seat portion is in the extended position.

A seat assembly, comprising: a seat base; a seat portion movably coupled to the seat base; a seat portion adjuster coupled to the seat base and the seat portion, the seat portion adjuster including: a bracket connected to the seat base; an actuator connected to the bracket; a linkage coupled to the seat portion, the bracket, and the actuator, the linkage including a first lever, a second lever, a third lever, and a fourth lever; wherein the first lever is rotatably coupled to the bracket, the second lever, and the fourth lever; the third lever is rotatably coupled to the bracket and the fourth lever; and the second lever and the fourth lever are rotatably coupled to the seat portion.

The seat assembly of any preceding embodiment, wherein the linkage includes a seat portion bracket rotatably coupled to the second lever and the fourth lever; the seat portion includes a calf rest having a cushion connected to the seat portion bracket.

The seat assembly of any preceding embodiment, wherein the linkage includes an additional first lever, an additional second lever, an additional third lever, and an additional fourth lever; the additional first lever is rotatably coupled to the bracket, the additional second lever, and the additional fourth lever; and the additional third lever is rotatably coupled to the bracket and the additional fourth lever.

The seat assembly of any preceding embodiment, wherein the linkage includes a cross member connected to the first lever, the additional first lever, and the actuator; the cross member includes an offset portion; and the actuator is coupled to the offset portion.

The seat assembly of any preceding embodiment, wherein the actuator is coupled to the first lever via a cross member; and the actuator includes an electric motor, a nut, and a threaded rod.

The seat assembly of any preceding embodiment, wherein the first lever is rotatably coupled to the bracket at a first rotation axis; the cross member is connected to a first lever portion of the first lever that is offset from the first rotation axis; the first lever is rotatably coupled to the second lever at a second rotation axis; and the first lever portion is offset from the second rotation axis.

The seat assembly of any preceding embodiment, wherein the first lever is rotatably coupled to the bracket at a first rotation axis; the first lever is rotatably coupled to the second lever at a second rotation axis; the first lever is rotatably coupled to the fourth lever at a third rotation axis; and the first rotational axis, the second rotational axis, and the third rotational axis are offset from each other.

The seat assembly of any preceding embodiment, wherein the first lever is rotatably coupled to the fourth lever at a third rotational axis; and in a retracted position of the seat portion, the first rotational axis is disposed at a greater height than the third rotational axis, which is disposed at a greater height than the second rotational axis.

The seat assembly of any preceding embodiment, wherein the third lever is rotatably coupled to the bracket at a fourth rotational axis; the third lever is rotatably coupled to the fourth lever at a fifth rotational axis; the second lever is rotatably coupled to the seat portion at a sixth rotational axis; the fourth lever is rotatably coupled to the seat portion at a seventh rotational axis; in the retracted position, the first rotational axis is disposed at a greater height than the sixth rotational axis and the seventh rotational axis; and in an extended position of the seat portion, the sixth rotational axis and the seventh rotational axis are disposed at a greater height than the first rotational axis.

The seat assembly of any preceding embodiment, wherein the actuator includes a motor operably coupled to a pinion; the linkage includes a cross member and sector gear; and the sector gear is connected to the cross member and engaged with the pinion.

The seat assembly of any preceding embodiment, wherein the sector gear is fixed to the cross member; the first lever is fixed to the cross member such that rotation of the sector gear via the motor and the pinion causes rotation of the first lever; and the first lever is rotatably coupled with the bracket via the cross member.

The seat assembly of any preceding embodiment, wherein the fourth lever includes a J-shaped configuration.

The seat assembly of any preceding embodiment, wherein a total length of the seat portion adjuster is 70% or less of a total width of the seat portion adjuster.

The seat assembly of any preceding embodiment, wherein a total height of the seat portion adjuster is 70% or less of the total width of the seat portion adjuster.

The seat assembly of any preceding embodiment, wherein the total length is between 150 mm and 175 mm, and the total height is between 155 mm and 180 mm.

The seat assembly of any preceding embodiment, wherein the second lever and the fourth lever have the same configuration.

The seat assembly of any preceding embodiment, wherein the seat portion has a retracted position and an extended position; and a position of the first lever when the seat portion is in the retracted position is offset by at least 75 degrees from a position of the first lever when the seat portion is in the extended position.

The seat assembly of any preceding embodiment, wherein the seat base is coupled to a track assembly configured for connection with a mounting surface; and the cushion includes a recess configured to receive a portion of the track assembly and/or a portion of the mounting surface in a retracted position of the seat portion.

The seat assembly of any preceding embodiment, wherein the cushion includes a trapezoidal configuration.

The seat assembly of any preceding embodiment, wherein the mounting surface includes a pair of raised portions separated by a lower portion; the cushion includes a first portion that is wider than the lower portion; and the cushion includes a second portion that is narrower than the lower portion and disposed at least partially between the pair of raised portions when the seat portion is in the retracted position.

A calf rest adjuster, comprising: a bracket connected to the seat base; an actuator connected to the bracket; and a linkage coupled to the bracket and the actuator, the linkage comprising: a first lever; a second lever; a third lever; a fourth lever; and a calf rest bracket; wherein the first lever is rotatably coupled to the bracket, the second lever, and the fourth lever; the third lever is rotatably coupled to the bracket and the fourth lever; and the second lever and the fourth lever are rotatably coupled to the calf rest bracket.

The seat assembly or calf rest adjuster of any preceding embodiment, wherein the linkage includes an additional first lever, an additional second lever, an additional third lever, and an additional fourth lever; the additional first lever is rotatably coupled to the bracket, the additional second lever, and the additional fourth lever; the additional third lever is rotatably coupled to the bracket and the additional fourth lever; and the additional second lever and the additional fourth lever are separately rotatably coupled to the calf rest bracket

The seat assembly or calf rest adjuster of any preceding embodiment, comprising a cushion connected to the calf rest bracket.

A vehicle comprising any preceding embodiment.

A vehicle comprising the seat assembly of any preceding embodiment.

A vehicle comprising the calf rest adjuster of any preceding embodiment.

An electronic controller configured to implement the method of any preceding embodiment.

A non-transitory computer-readable storage medium having a computer program encoded thereon for implementing the method of any preceding embodiment.

In examples, a controller (e.g., the electronic controller 42) may include an electronic controller and/or include an electronic processor, such as a programmable microprocessor and/or microcontroller. In embodiments, a controller may include, for example, an application specific integrated circuit (ASIC) and/or an embedded controller. A controller may include a central processing unit (CPU), a memory (e.g., a non-transitory computer-readable storage medium), and/or an input/output (I/O) interface. A controller may be configured to perform various functions, including those described in greater detail herein, with appropriate programming instructions and/or code embodied in software, hardware, and/or other medium. In embodiments, a controller may include a plurality of controllers. In embodiments, a controller may be connected to a display, such as a touchscreen display.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” “an embodiment,” “with some configurations,” “in some configurations,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” “an embodiment,” “with some configurations,” “in some configurations,” or the like, in places throughout the specification are not necessarily all referring to the same embodiment. Furthermore, the particular features, structures, and/or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof. The word “exemplary” is used herein to mean “serving as a non-limiting example.”

It should be understood that references to a single element are not necessarily so limited and may include one or more of such element, unless the context clearly indicates otherwise. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above. The term “at least one of” in the context of, e.g., “at least one of A, B, and C” or “at least one of A, B, or C” includes only A, only B, only C, or any combination or subset of A, B, and C, including any combination or subset of one or a plurality of A, one or a plurality of B, and one or a plurality of C.

Although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. The term “and/or” as used herein refers to and encompasses any and all possible combinations of one or more of the associated listed items Uses of “and” and “or” are to be construed broadly (e.g., to be treated as “and/or”). For example and without limitation, uses of “and” do not necessarily require all elements or features listed, and uses of “or” are inclusive unless such a construction would be illogical. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

A controller, an electronic control unit (ECU), a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

An article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A seat assembly, comprising:
a seat base;
a seat portion movably coupled to the seat base; and
a seat portion adjuster coupled to the seat base and the seat portion, the seat portion adjuster including:
a bracket connected to the seat base;
a motor operably coupled to the bracket; and
a linkage coupled to the seat portion, the bracket, and the motor, the linkage including a first lever, a second lever, a third lever, and a fourth lever;
wherein the first lever is rotatably coupled to the bracket and the second lever,
the third lever is rotatably coupled to the bracket, the second lever, and the fourth lever; and
the second lever and the fourth lever are rotatably coupled to the seat portion.

2. The seat assembly of claim 1, wherein the linkage includes a fifth lever rotatably coupled to the second lever, and a sixth lever rotatably coupled to the fifth lever and the seat portion.

3. The seat assembly of claim 2, wherein the second lever is rotatably coupled to the seat portion via the fifth lever and the sixth lever.

4. The seat assembly of claim 3, wherein the linkage includes a seat portion bracket rotatably coupled to second lever and the sixth lever; and
the seat portion includes a calf rest including a cushion connected to the seat portion bracket.

5. The seat assembly of claim 3, wherein the fifth lever is rotatably coupled to a middle section of the second lever.

6. The seat assembly of claim 5, wherein the third lever includes a third lever first section and a third lever second section laterally offset from the third lever first section.

7. The seat assembly of claim 6, wherein the fourth lever includes a fourth lever first section and a fourth lever second section laterally offset from the fourth lever first section; and
the sixth lever includes a sixth lever first section and a sixth lever second section laterally offset from the sixth lever first section.

8. The seat assembly of claim 7, wherein the bracket includes a bracket first section and a bracket second section laterally outward of the bracket first section;
the first lever is rotatably coupled to the bracket first section;
the third lever first section is rotatably coupled to the bracket second section;
the third lever second section is rotatably coupled to the fourth lever first section; and
the fourth lever second section is rotatably coupled to the fifth lever.

9. The seat assembly of claim 8, wherein the seat portion adjuster includes a cross member operably coupled to the motor and the third lever first section such that operation of the motor rotates the third lever relative to the bracket.

10. The seat assembly of claim 8, wherein the bracket first section is disposed rearward of the bracket second section.

11. The seat assembly of claim 1, wherein the linkage is a first linkage; and
the seat portion adjuster includes a second linkage including a second linkage first lever, a second linkage second lever, a second linkage third lever, and a second linkage fourth lever.

12. The seat assembly of claim 11, wherein the first linkage includes a first linkage fifth lever and a first linkage sixth lever; and
the second linkage includes a second linkage fifth lever and a second linkage sixth lever.

13. The seat assembly of claim 11, wherein the seat portion adjuster includes a cross member connected to the first lever of the first linkage, the second linkage first lever, and the motor.

14. The seat assembly of claim 13, wherein the cross member includes an offset portion; and
the motor is coupled to the offset portion.

15. The seat assembly of claim 13, wherein the first linkage includes a first linkage fifth lever and a first linkage sixth lever;
the second linkage includes a second linkage fifth lever and a second linkage sixth lever; and
the seat portion adjuster includes a second cross member connected to the first linkage fifth lever and the second linkage fifth lever.

16. The seat assembly of claim 1, wherein the seat portion has an extended position in which the seat portion is disposed at a first angle and a retracted position in which the seat portion is disposed at a second angle; and
a difference between the first angle and the second angle is at least 50 degrees.

17. The seat assembly of claim 16, wherein the difference is at least 70 degrees.

18. The seat assembly of claim 16, wherein, in the retracted position, the seat portion is within 10 degrees of vertical.

19. The seat assembly of claim 18, wherein, in the extended position, the seat portion is within 20 degrees of horizontal.

20. The seat assembly of claim 1, wherein the seat portion has an extended position and a retracted position;
the linkage includes a fifth lever and a sixth lever;
the second lever is rotatably coupled to the seat portion at a seat portion first axis;
the sixth lever is rotatably coupled to the seat portion at a seat portion second axis;
the seat portion first axis is disposed at a greater height than the seat portion second axis when the seat portion is in the retracted position; and
the seat portion first axis is disposed at lower height than and rearward of the seat portion second axis when the seat portion is in the extended position.
